(19) United States
(12) Patent Application Publication
(10) Pub. No.: US 2012/0173281 A1
(43) Pub. Date: Jul. 5, 2012

(54) AUTOMATED DATA ENTRY AND TRANSCRIPTION SYSTEM, ESPECIALLY FOR GENERATION OF MEDICAL REPORTS BY AN ATTENDING PHYSICIAN

(76) Inventors: James M. DiLella, Bala Cynwyd, PA (US); Raymond W. Lesser, Ardmore, PA (US); Anantharavi V. Manabala, Marietta, GA (US); Max L. Ronis, Philadelphia, PA (US)

(21) Appl. No.: 12/984,652

(22) Filed: Jan. 5, 2011

(51) Int. Cl. G06Q 50/00

(52) U.S. Cl. 705/3

(57) ABSTRACT

Written reports are composed using a terminal during or between patient encounters. Selections made on the terminal invoke standard text segments and a narrative comment is recorded, by dictation or otherwise. After a series of patient encounters, such as at the end of the day, automatically generated draft reports are reviewed, revised and dispatched by the practitioner or staff, in a batch process. The terminal accepting selections and comment can be a wireless Web-capable smart-phone or another terminal running an application to interface with the practitioner. The application presents selections for each of a menu of categories, for example common conditions and maladies encountered in specialized practices. The practitioner distinguishes between normal entries that populate the report with standardized comments (or optionally go unreported), versus noteworthy entries that populate the report with preferably speech-recognized text.

### BACKGROUND

1. Field of the Invention

This disclosure concerns improving the efficiency of systems and methods for collecting information and generating reports. An aspect is to merge information developed from a combination of user selections and database look-ups, together with customized narrative text. The technique is particularly applicable to generating reports on professional services, such as correspondence and file memos to document the process of medical examinations or procedures conducted by an attending physician and reported to a referral source or client file, and to update patient information systems.

2. Prior Art

An aspect of providing ongoing services to customers is to maintain and update records of information for future reference in connection with ongoing provision of such services. Various services have their own parameters and variables that are pertinent and are aptly recorded and used in generating reports of various types. In connection with expert professional services, such as medical services rendered by an attending physician, the information collected and reported may be highly specialized to a medical practice, and variable with the context of the situations and conditions presented by the patients. The reports need to be complete in that predetermined points are addressed. The reports must be accurate as to details, and also potentially deep in the breadth and implications of information reported, conclusions reached and so forth.

For medical services, the traditional notion is to maintain a file for each medical patient, i.e., a file of paper copies of records on patient visits, notes on physician impressions, descriptions of procedures conducted, test results, and associated correspondence. The specific information needed may vary with the role of the professional. A primary care physician may need information on patient history with less detail than a specialist treating a patient for a specific condition. However the primary care physician also may depend on conclusions and summaries from the specialist in conferring with the patient about treatment options. Information that is collected and stored increasingly comprises electronically encoded information in databases. Narrative information is also collected, in the form of in hand written notes and entries in paper files, or in the form of narrative descriptions and data that are stored in document management and word processing data files.

Electronic data such as medical information contained in computer database records often includes entries in database fields for information parameters that are aptly encoded as numeric values, short character strings or selections among a list of options. For example, form-driven and computerized data lends itself to documentation using boxes filled in with numeric or text string data, or menu-driven data entry processes. This is efficient up to a point, especially if the intent is to enter values for fields that are expressed as numbers or measurements (e.g., age or weight), or values that are selected from a closed list of possible alternative entries, such as yes-or-no responses to queries, check boxes for a limited choice of options such as M or F for gender, and other menu selections.

Databases also can include free form text fields under some heading. Shorter or longer and more or less variable strings of text are possible using closed lists of possible entries or free form fields that are filled in as desired. Closed lists of possible entries are helpful for data processing functions because the same terms appear and enable sorting and lists and the like. But free form fields are versatile because one can customize the entry for the patient.

Free form prose descriptions might relate to medical history, current state, complaint or presented condition, treatment options, records of procedures, prognosis, physician's impressions and recommendations for future actions, schedules, etc. Narrative free form explanations under such headings might be saved in a database and made accessible for later reference, for searching or for other use. Narrative explanations are relatively rich in meaning, compared to short text strings. A narrative is capable of conveying physician impressions in concepts with shades of meaning embodied by the author's choice of terms and language. Physicians are trained and experienced in conversing with one another in narrative explanations.

It is typical for physicians to encounter many patients that present similar conditions. The diagnoses for the patients may fall into a limited list of commonly encountered diagnoses, especially for specialists practices. The physician may treat conditions in a limited number of ways. Under these conditions, there are efficiencies to be realized by using closed lists of possible values.

Additionally, closed lists, menus with options and forms for collection of numeric values are advantageous in terms of accuracy when computerized. Once a field or choice has been entered correctly with respect to an item of information that does not change, the values are dependably accurate from then on. It is efficient to employ values that are verified instead of re-entering data that might introduce errors. But the information conveyed in closed list or numeric fields and check boxes is sparse compared to narrative explanations.

If one is required to use short string data values or to choose among a list of alternative terms or phrases, there is a tendency to employ abbreviations or to accept values or choices that are the nearest acceptable alternative to the value that might have been preferred. One is inclined to choose among the other alternatives even if an “other” or “none of the above” option is offered. Information carried by forms therefore is less rich or substantial as to the meaning carried, and also is apt to convey inaccurate or incomplete information, compared to a more customized technique for recording information.

It would be advantageous to strike an efficient balance between handling free form data and handling closed lists. What is needed is to exploit computerized or other check-box and short answer forms where appropriate, and to provide for customized explanations and notations where forms are not adequate. Documentation produced for inclusion in a patient information file, such as medical reports and treatment histories, etc., advantageously contain some forms, but also contain notes and explanations that a physician or technician has used to memorialize various values or facts.

It is a standard practice of physicians who operate specialty practices to receive referrals from primary care physicians in general practice. A few examples of specialty practices include orthopedics, endocrinology, dermatology, ophthalmology, otolaryngology (ear-nose-throat), cardiology, gastroenterology, obstetrics and gynecology, urology, oncology, podiatry, etc. These specialty practices likewise have subspecialties and crossovers such as surgery with respect to particular anatomical categories. In connection with providing medical care, physicians frequently refer patients to one another, especially to employ specialized medical practices for specific medical needs.

The attending physician in the specialized practice provides care to the patient and typically reports back to the referring or primary care physician, or to a related entity (such as an institution). Both the specialist and the referring physician maintain files where patient information is stored accessibly for future reference, possibly in connection with ongoing or follow-up care. The respective physicians may have access to a shared database of medical history on the patients they have in common.

However, the typical scenario also includes correspondence passed from the specialist to the referring physician. The correspondence might be in paper or by facsimile or by electronic messaging or by other media. In part this is business correspondence, for example to acknowledge the referral, to thank the referring physician for his/her confidence, to establish and maintain a continuing relationship. The correspondence also comprises a technical medical report. The report identifies the patient and typically includes a statement of the observed state of the patient, the nature of the patient's complaint or medical issue, pertinent background or historical information provided by the patient or found in the file (whether or not computerized), an explanation of tests or procedures undertaken and the results, perhaps a prognosis or a schedule for future visits to follow up, etc.

Reporting back to the referring physician and attending to completing and updating patient information files (electronically or on paper) consumes a great deal of time and attention. The referred specialist may attend to files and draft reports as part of his/her day to day operations. Typically some of this effort is delegated to staff or to outside vendors.

The specialist may type or dictate reports to a file or letters to referring physicians or other entities. This is done after the patient's appointment because it would be rude or distracting for the specialist to dictate or type out a report in the patient's immediate presence. The report generation process is partly a word processing operation and physicians may employ stenographers or refer transcription requirements to a medical transcription service. Services may be provided with a file identifier or an audio tape charged with preparing a word processor file from the dictation for the physician to review. These services can be more or less sophisticated, some being capable, for example, to extract data field values from the text in a transcribed report for inclusion in a patient's electronic medical record (or EMR, also known as an electronic health record EHR). The production of the dictation also can be automated to some extent using speech recognition software (such as the Dragon Naturally Speaking products from Nuance Communications or Loquendo ASR).

Medical healthcare technology is currently developing in the area of EMR/EHR but typically databases of information in this field do not favor free form text fields and instead tend to use a thesaurus of accepted terms from which a physician or other person must choose when attempting to characterize their impressions of a patient's condition and treatment. There is a need to exploit the potential for incorporating report transcription into the area of EMR/EHR, providing standardized definitions without forcing the physician to accept terms that have standardized definitions that might not be wholly apt. Up to now, dictation and transcription are practiced but are substantially independent of EMR/HER applications.

Although automated speech-text conversion is increasingly effective, the typical transcription solution involves outsourcing transcriptions to human stenographers. A current service from EPIC permits a physician to dictate a description of the patient's history and condition, normal and abnormal attributes and any impressions as a complete body of content, thus generally dictating the whole of the content of a report. The report may be revised to include letterhead, appropriate addressing, salutation and signature portions in later steps. However the dictation is by telephone, optionally during but more likely after the patient encounter. The audio is transcribed from a recording by a service employing human stenographers. The transcription service is charged by the word or character or line count, or by the minute of recorded audio or by other measures. If the transcription service is also employed to make corrections, additional charges apply. When the document or file is received from the service, the physician or designated staff member typically makes any further changes needed in a word processing program such as Microsoft Word, and finalizes and disposes of the correspondence or other report.

It is possible to exploit Dragon speech recognition or a similar software process to produce word processing text from dictation, and to do so in connection with the report of an attending physician. Typically, the physician dictates into a stationary microphone at his word processing computer, after the patient encounter. Handheld audio recorders are known that can produce data files, for example from Olympus, in sampled audio files (e.g., way) or compressed audio files (e.g., MP3), which can be used as input for a Dragon speech recognition application. The Dragon system has the capability of being configured specifically to accept medical terminology.

The physician dictates text for one patient at a time. It is necessary as a practical matter to distinguish among patients by separately handling their files and dictation as distinct blocks of text, preferably soon after the patient encounter with the benefit of hand written notes. Attempting to dictate for a patient after encounters with other patients or at the end of a day might introduce errors or lead to omissions where details have been forgotten.

What is needed is a way to facilitate the collection of data, including not only narrative information but also field values, that is minimally intrusive to physicians' practices, reduces the time spent on dictation to a minimum, enables rich customized content and is associated with data accessibility features that facilitate the production of reports and the recording of associated information.

### SUMMARY

According to an aspect of the present disclosure, written reports are composed in part from data selection entries by an attending physician on a programmed terminal. In one embodiment the terminal is a wireless telephone with data access capabilities (a smart phone). A wired terminal coupled to a LAN or a wireless terminal of another description or other terminal device can also be employed. The report can be associated with a patient appointment, optionally including information pulled from a patient information and appointment database. The selections presented by the programmed terminal include a series of topics, information on which can be pulled in part from the patient information database and also entered on the terminal device and used to populate fields in the patient information database.

The selections can be standardized to encompass a range of inquiries that are pertinent to the patients conditions and treatments. According to one embodiment, the selections include topics associated with one of a practice specialty, a patient category or category of patient complaint, a value associated with a patient history.

In one aspect associated for example with physical examinations, the selections enable the physician to distinguish between normal or nominal and abnormal or suspicious categories, and in connection with selected categories (especially normal/nominal findings), to elect to omit mention of that category in a report. A nominal category can be simply indicated as such, then moving on to a next category. An abnormal/suspicious category can invoke a further menu of topics or categories. Categories that are deemed abnormal/suspicious also are associated with entry of a free form text discussion.

The text discussion preferably is dictated into the audio input of the terminal, such as a data capable wireless telephone (a so-called “smart phone”), digitized and reported as an audio file from which speech-to-text transcription produces a word processor data file. The data selections and dictation are preferably effected substantially contemporaneously with patient visits, and are managed as elements of a work flow.

At a later time such as after patient appointments have been concluded, the physician's attention is turned to reviewing and editing reports. Inasmuch as the dictation is associated as a work flow step with a patient appointment, the patient identifying and demographic information may be pulled from a database together with the name and address of the referring physician and other parameter values or strings. Aspects that were identified by the physician as nominal are used to selectively insert predetermined descriptions associated with a nominal condition for a patient as otherwise described with respect to other parameters, such as age, gender, weight, etc. The dictated text is fit into the composed report together with the predetermined descriptions. In batch mode processing, proposed reports generated for each of the day's appointments are offered to the physician to approve or edit.

The specific reports can vary as to type, for example including memos to file, reports to referring physicians or institutions, orders for tests or further services, reports for patients or patient famines, physical condition reports required for athletic participation, by academic institutions or employers, etc. Examples detailed herein include categories and reports that are adapted for specialty practices. General practices and primary care practices may also employ similar techniques.

An object is to exploit automation while eschewing pigeon-holing of patient information into a limited set of alternative variable descriptions and alternative text or numeric values. At the same time, automation is exploited for workflow control, speech-to-text transcription, review and to facilitate review and text editing. Entries are dictated for categories of information that are deemed by the attending physician to be other than nominal. Dictated entries are speech-to-text transcribed. A report is produced by merging fields and entries identifying the author, report recipient (if any), patient identification and history, a summary of conditions that are nominal or at least routine, material findings, and customized text for categories that are other than nominal or otherwise apt for comment.

The workflow arrangements preferably are coupled to a patient information and appointment scheduling system such that each patient encounter can produce a draft report. In one embodiment, the reports are letters reports addressed to a referring physician or practice. The dictation, transcription, and report composition processes can employ a wireless handheld unit such as a Web-data accessible telephone, coupled to a data communication network, and advantageously used to record information and comments substantially contemporaneously with or immediately after patient appointments. Preferably, an audio file is saved together with an automated text transcription. Time stamp metadata is also stored for synchronizing the text to a time position in the audio playback.

Outside of scheduled appointment times, for example at the end of the day, the attending physician or a clerical assistant accesses the data communication system over the network to review and edit reports. The reports contain certain sections resulting directly from automated lookups, such as the name and address information of the attending and referring physicians or the like, the patient name and address, all accurately pulled from a database. Report categories that are deemed nominal can be selected for inclusion or omitted. If selected and indicated to be nominal, the categories can be selected for population with pre-stored sentences or paragraphs. If otherwise selected, and in particular if other than nominal, customized entries are required. Preferably the selections are made and the customized entries are authored by or at least approved by the attending physician. The customized entries are inserted as automated speech-to-text transcriptions from the recorded audio. If a change is to be made or a transcription appears to be anomalous, the reviewer can queue an audio playback of the dictation time synchronized to the questionable transcription text and hear the particular portion of the audio as dictated.

The disclosed system employs a process that can be operated using a wireless handheld coupled to a patient information and appointment scheduling system. This process accepts menu driven entries and also accepts dictation, preferably. The process distinguishes report information categories that the physician wishes reported or omitted. Reported by standardized report text or customized text

Data processing paperwork is the bane of many medical practices, which are required to collect and manage patient demographic information, for diagnosis of medical issues and potential referral to specialists, for receiving and appropriately handling information required to update patients medical histories, to manage health insurance claims and coverage, etc. Paperwork increasingly has been replaced by computerized databases and data processing systems, but it is not practical to provide a limited set of database fields and a closed set of all possible values for such database fields.

It is desirable in various fields to produce a report after conducting a procedure. Such reports are generally expected to encompass certain minimum topics. It is in some situations to have specified succession of required topics, including where an entry on a particular topic may queue additional topics. In different applications, the recordation of topics can follow a more generalized agenda.

### BRIEF DESCRIPTION OF THE DRAWINGS

There are shown in the drawings certain exemplary embodiments for purposes of illustration. It should be understood that the invention is defined in the claims below and is not limited to the embodiments specifically disclosed as examples. In the drawings,

FIG. 1 is a schematic overview showing certain operational entities, elements and steps according to an exemplary embodiment of the subject data entry and transcription apparatus and method.

FIG. 2 is a block diagram showing certain modular portions of the subject apparatus and method.

FIG. 3 is an illustration of an exemplary practitioner interface display screen, shown on a wireless terminal device and representing categories, attributes and selections that the practitioner can invoke according to the subject methods.

FIG. 4 is an abbreviated flowchart showing the progress of a patient consultation.

FIG. 5 is an abbreviated flowchart showing communication and processing steps by which selections made as in FIG. 3 are processed and combined with narrated free form text to produce the contents of a draft report.

FIG. 6 is an abbreviated flowchart showing review, revision and approval steps by a physician or other person engaged to finalize and discharge the report.

FIG. 7 is a detailed flowchart demonstrating activities performed cooperatively by a practitioner (e.g., a physician) interacting with a programmed application running on and via the terminal device as in FIG. 3, such as a smart phone.

FIGS. 8a-8c are screen shots typical of operation of the wireless terminal outside of the time of a patient encounter, such as between appointments.

FIG. 9 is screen shots on a wireless terminal according to an example using a touch screen smart phone, showing a screen presented during an exemplary encounter, in this case an examination and/or diagnostic encounter with a patient by a specialist, the particular example being the specialty of otolaryngology (ear/nose/throat).

FIG. 10 is a theoretical illustration of the full length of the screen field that is accessible by expanding certain sections (shown by brackets) and if the display in FIG. 9 were to be scrolled to present the available contents from beginning to end.

FIG. 11 is a screen shot illustrating an examination phase in a cardiology practice for comparison, with the subject matter being applicable to general practice or various specialties and other uses.

FIGS. 12a through 12c are detailed flowcharts more specifically demonstrating the steps shown generally in FIGS. 4-6

FIGS. 13-15 show typical screen shots encountered when logging onto a terminal coupled to the system, typically on a desktop unit, selecting reports for transcription and editing and reviewing and editing machine transcriptions. This phase can include replaying the recorded audio at a selected line, sentence, phrase or other subdivision.

FIG. 16 shows an exemplary final report with text selected from stored entries according to selections originally entered by the practitioner on the wireless terminal, corrected free form text generated from the narration, and optionally including insertions such as graphics and imaging.

FIG. 17 is a flowchart showing aspects of the interface between the physician or other practitioner and the system, using the practitioner interface terminal, such as the wireless smart phone as shown.

FIG. 18 is a flowchart showing the operation of the interface terminal in connection with free text entry by the physician or other practitioner.

### DETAILED DESCRIPTION

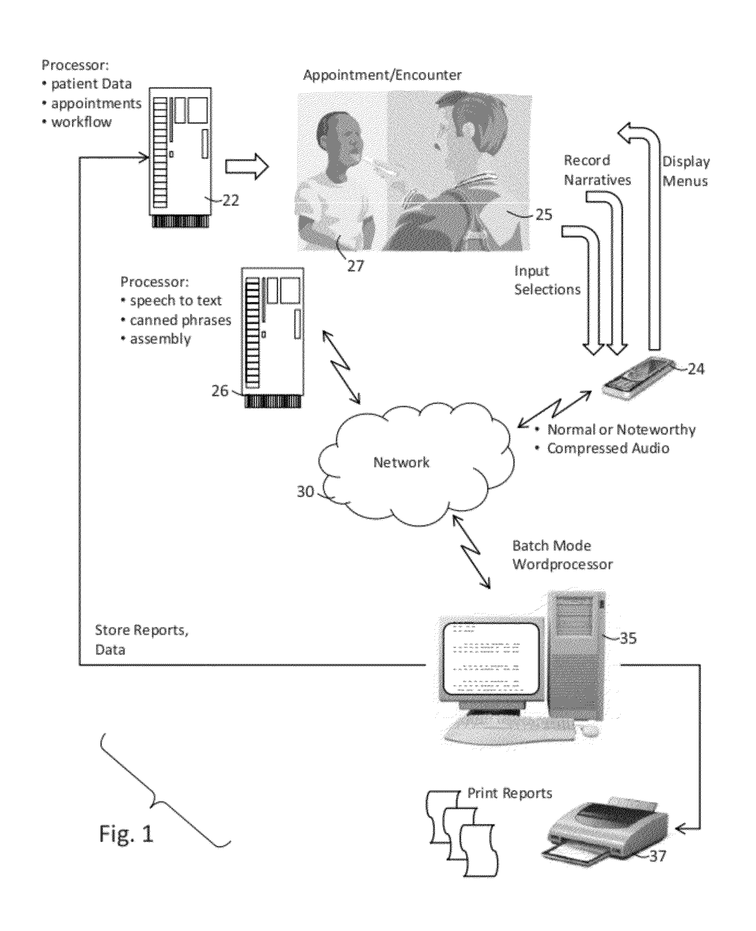

FIG. 1 is a broad perspective view of the subject automated data entry and transcription system and method. The disclosed system is especially useful for generation of medical reports by a physician who has a series of patient encounters to which to attend. In addition to assisting in scheduling, maintaining records and providing medical services or the like, the system is useful when it is necessary or desirable to merge information into a final report, such as a reporting letter or a memo-to-file memorializing the encounter.

In a typical patient encounter, examination or other procedure and report, it is necessary to identify the persons involved and to take note of aspects of their situation and history. The aspects that are important are affected by the reason for the encounter and the ensuing steps and results of questioning, examination, treatment and follow-up. At least the patient is identified and associated with corresponding records. In FIG. 1, at least one processor 22 is provided with patient information that may be more or less extensive and provides for initiating a record for the patient encounter.

At least one terminal device 24 is provided for data communications with the processor 22 and is operated by a practitioner 25 or associated staff person in connection with an encounter with the subject, e.g., a patient 27 for medical services

The subject/patient 27 may be a new patient whose records are to be originated, a patient whose information is obtained from another database such as that of a health management organization of the like, or a returning patient whose treatment is ongoing and for whom some information has already been obtained. The condition presented and/or the nature of the examination or procedure are noted, and necessary information is determined from the subject or by reference to information that may be stored in a medical information database or found in a paper file. Information such as prompts for required information are presented to the attending physician or other operator 25, who responds by making menu selections, responding to presented options, optionally entering text and numbers as responses, and so forth. In this connection, the terminal device 24 can comprise an onboard processor and wireless or other data communications capability, the terminal device being programmed to cooperate with the processor 22 that handles appointments, scheduling and patient encounter workflow management.

The respective functions of patient encounter workflow and also recordation of information are shared between processor 22 and terminal device 24 and can be allotted more or less to one or the other. The terminal device advantageously is programmed to enable the attending physician 25 to proceed according to a suitable workflow category for the patient encounter, such as a medical specialty of the physician's practice. Optionally, the workflow category can be selected by the physician from plural categories that are either stored at terminal device 24 or downloaded to terminal device from the processor 22. Any information critical to the encounter can also be downloaded from at least one associated processor, such as from appointment/workflow processor 22 or from another processor 26 more generally associated with maintaining a medical information database, so that the necessary information is displayed at or is accessible to the physician 25 at the terminal 24.

Proceeding according to the workflow generally includes addressing a list of topics typical of medical practice, which can be displayed under control of a programmed process running on terminal device 24. The physician 24 interacts with the patient 27, responds to the menu categories by making selections or entering data. Either the raw data or a processed version of the raw data is stored at one or more of processors 22, 26 and terminal device 24, and used to generate portions of report by automated means. In particular, certain optional selections or Boolean combinations of selections are used logically to select pre-stored phraseology in selected parts of the report. Advantageously, a free form narrative portion is also input by the physician or his/her designee.

In the embodiment shown in FIG. 1, the terminal 24 is a wireless handheld terminal such as a so-called smart phone or Web-capable wireless terminal in data communication over a cellular or Wi-Fi data connection or the like. This form of terminal is apt for accepting and recording an audio dictation for the free form part of the report. The audio can be digitized and stored, preferably in a compressed data format, at one or more of terminals 22, 24, 26, and subjected to a speech-to-text transcription algorithm for generating word processor text to be inserted into a partly-robotically produced report. It is also possible to embody the system such that the terminal 24 is a portable or laptop or desktop terminal in data communication with the other processors and devices 22, 26 by wired or wireless data connections via a LAN, WAN, cellular or other technique over a network 30. If a keyboard is available on the terminal (such as a keypad or touch-screen keyboard), some or all of the narrative can be entered by keystrokes. In a preferred arrangement, keystrokes and selection clicks are used for making selections among alternatives such as menu options, and the free form narrative is used for entering physician impressions and recommendations, especially by dictation recorded either concurrently with or shortly after the encounter with the patient or other subject.

The system comprises a programmed data processing system having certain special purpose elements and subsystems working in concert. At least one data terminal 24 is provided for operation by or for the practitioner, who may have access to a terminal 24 comprising a smart phone as suggested in FIG. 1 and also have access to a desktop terminal 35 with another processor in data communication over the same network 30. The data terminals 24 and/or 35 provide one or more facilities by which the practitioner is able to display prompting information, to input data including certain selections in response to the prompting, and is also able to input at least one free form narrative. The selections and the narrative relate to the subject or patient 27 and relate to a process involving the subject or patient, such as a medical examination and/or treatment.

The respective processors 22, 24, 26, 35 include programming and data memory and are configured for communication over the network 30. The processors include at least one data terminal that may be made more or less capable, and is useful alone or together with other terminals and processors for prompting the practitioner for input, and accepting data entry including a narrative (such as a handheld 24). In different embodiments, these functions or portions of them can be limited to particular devices or functions that can be invoked optionally on two or more of the processors, each of which is capable of serving the necessary functions or parts thereof alone or in conjunction with one or more of other processors and associated input/output devices capable of information display and accepting input.

One or more of the processors, such as processors 22 and/or 26 in FIG. 1, include in addition to program memory at least one database of information. FIG. 1 shows two processors 22, 26 of which processor 22 has a workflow management and patient information database and processor 26 has a database of information associated with report generation. It should be appreciated that other specific allocations of these functions are possible. For example, the functions of processors 22, 26 might be combined in one unit, or patient information could be stored at still another processor (not shown in FIG. 1), accessible in “the cloud.” In any event, one or more processors contain records relating to at least one of the subject 27 and the process undertaken with the subject, such as a medical examination or medical procedure undertaken on a patient. The processor(s) is/are programmed to associate the subject or patient and input selections and data entered, with information from the records.

A partly automated programmed report generator produces a report containing at least part of the narrative, inserts portions of the information from the records into the report based upon the input selections that are made and the available existing information regarding the subject or patient.

In the illustrated embodiments, the procedures are exemplified by medical test and examination procedures conducted on a patient as the subject. The invention is likewise applicable to other situations that similarly involve an encounter including the collection of information and association of that information with stored information to develop a report. In general, there are three modular portions that operate in concert; however, in different embodiments, these modules can be supported by programmed processes in one computer system or in two or more separate computer systems that are in data communication with one another. Each such system has a programmed processor, input and output facilities and a memory.

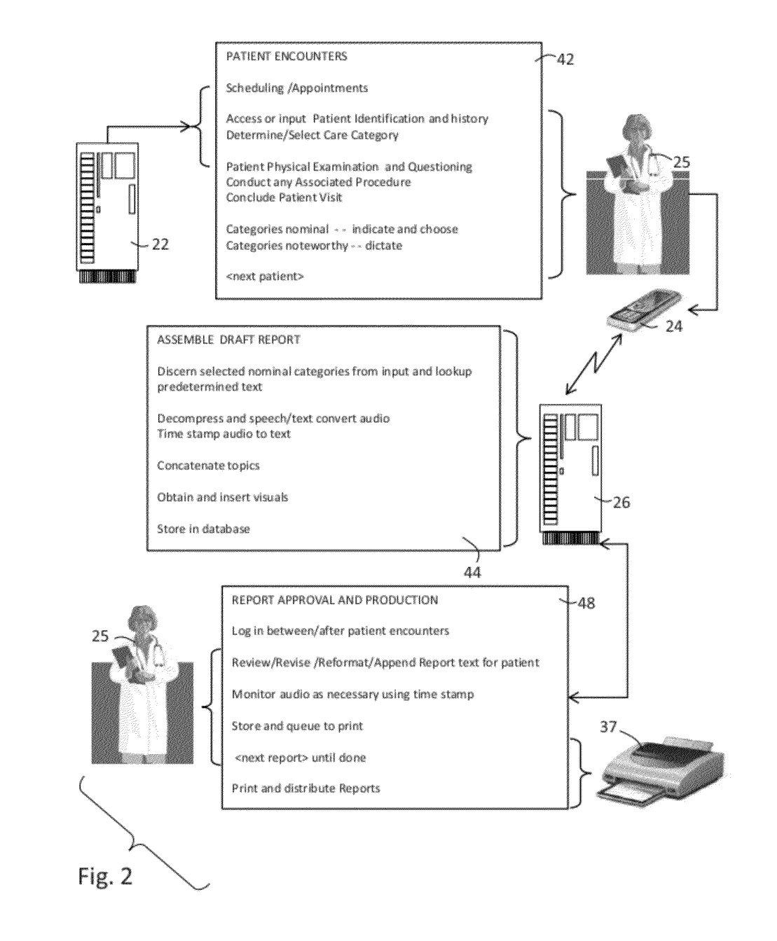

Referring to FIG. 2, the modules comprise a subject encounter and data collection module 42, a transcription and assembly module 44 and a report review and editing module 46. The subject encounter module 42 is operable under control of its programming and input from the practitioner to collect information regarding the subject. This information can be obtained in part from previously stored information, from questioning the subject, from a remote source of patient information, and from data entry by the operator, such as a physician or a technician assisting a physician. The data is primarily developed by information access prior to the encounter, and by data entered during and preferably promptly after the encounter with the subject. It is also possible to include in the output report some information that is looked up or becomes available later, such as the results of laboratory tests, medical imaging or other graphics, etc.

The system is configured to support a workflow management operation that schedules subjects for encounters and organizes their information, for example as a part of the patient data processors 22 but also possibly as a stand-alone processor coupled to the network 30. This organization can include providing a framework for the examination or medical process, such as including offering options for selection or data entry on each of a list of topics on which the physician might typically make observations.

The framework for examination can relate to the practice of the physician or the physician's practice and to some extent determines the choice of topics that are appropriate to memorialize in the report. Thus the normal topics of interest to a primary care physician differ from the topics of interest to a specialty medical practice. The topics of interest to different specialty practices differ, such as otolaryngology versus cardiology. Within a particular practice, topics may differ for the condition reported by the patient, such as an acute versus chronic pain. Topics may differ for the anatomical groupings affected, such as an earache versus a sore throat. The topics can also differ based upon data known about the patient, such as age or weight or lab test results. Thus, for example, an elderly person complaining of joint pain might be examined by an orthopedist with emphasis on possible diagnosis of arthritis that is not typical of a young athlete with joint pain.

It is beyond the scope of this disclosure to define how the interplay of historical patient health information, current measurements, the nature of the patient's complaint and the nature of the physician's practice should affect the appropriate inquiries and conclusions that the physician may consider and reach. However it can be appreciated that physicians in practice areas encounter patients with the same or similar underlying conditions repeatedly, and develop standard procedures for obtaining information, reaching diagnoses and proposing treatments. The disclosed system is particularly useful to serve up the topics that a physician prefers to use for collecting and analyzing pertinent information.

The interface between the computer system and the physician can be a desktop terminal, but advantageously includes a wireless terminal 24 as shown in FIGS. 1 and 2. The terminal 24 has a display screen or the like, capable of presenting information, especially in a menu format. A keypad or touch-screen input capability is provided for data entry. Using keys and selection switches to identify and click-select icons or labeled areas, the user selects options and indicates choices (similar to selecting among checkboxes on a form). Optionally, the user can enter at least some text, such as numbers and short text strings. Advantageous, and for inclusion in a report generated as the output, the operator has certain options to enter free form narrative text. With a desktop version of terminal 24 (not shown), the narrative might be typed. In a preferred embodiment, the terminal 24 comprises a smart phone or similar handheld unit with audio input capability by which a narrative can be dictated.

According to an aspect of this disclosure, some of the selections offered to the physician or other operator distinguish whether one or more observed patient conditions (determined by questioning, observation, testing or otherwise) is normal or abnormal, in categories that are prompted to the physician or operator, as explained more fully below.

The two possibilities of normal and abnormal are subject to interpretation. It should be appreciated that some disease or pathogenic conditions may produce symptoms or results that are not normal in a healthy person but might be expected to be observed if such a disease or condition is identified. For example, it may be normal and expected that a person with influenza to have a fever and complain of aches or a person with pneumonia has a cough.

According to an aspect of the invention, at least some of the topics presented to the physician for selection are identified as normal versus abnormal. The same idea of unremarkable (normal) versus remarkable (abnormal) might also be distinguished using other words having a similar connotation of expected versus unexpected, or nominal versus variant, or typical versus atypical, etc. The point is that the physician is prompted at the terminal 24 to select either at least one option for each category that has an associated pre-stored description expounding upon what is meant by normal or unremarkable or nominal or typical (or a similar descriptive expression), versus at least one alternative option for that category that does not fit the description that is pre-stored. Selection of the alternative option, which might be termed “remarkable” (or similar descriptive expression) triggers the system to expect the physician or other operator to provide a narrative description that expounds upon what is remarkable and why. Where selections identify a category as normal, the physician or operator is not required to expound with a narrative, because a pre-stored description expounding on what is normal will be inserted into the report for that category.

Preferably, whether to insert the pre-stored description into the report on a category indicated to be normal, is within the discretion of the physician, which discretion can be exercised by input selections on the terminal device 24. To summarize, the physician or operator is prompted category by category to select “normal” or “abnormal” as a category description for each prompted category, but is only expected to produce a narrative for a category if the selection for that category was “abnormal.” The selection of the “normal’ physician/operator can be permitted to trigger the report generation facilities to produce a canned segment for the category identified as normal, and optionally, the physician can suppress the canned segment and allow the report to omit to include the canned segment or to mention the normal category in the report.

Advantageously, the data entry includes the options to select normal (pre-stored description) or to enter at least one narrative for one or more and potentially for all of a list of subjects brought to the attention of the practitioner by prompting on the terminal device 24. The presentation of menus prompting the physician and the selection of the normal/abnormal descriptions is shown in FIG. 2 as part of the subject encounter and data collection module 42. In a practical embodiment, the physician continues through a workday or similar time period, successively encountering patients according to appointments scheduled and stored by the processor handling the patient data and workflow processes, such as processor 22 in FIG. 1. The resulting data is saved in that processor or in another processor 26 that can be provided for serving the transcription and assembly module 44 and/or report review and editing module 46, also shown in FIG. 2. The transcription and assembly module is operable under control of the programming to select from the memory the pre-stored segments of text associated with the normal selections and intersperse or concatenate the text segments for normal categories with narrative text entries on abnormal selection categories, to generate a report for each of the patients or other subjects.

The report is stored in draft form, for example on processor 26 in FIG. 1. Using the review and editing module 46, preferably in a batch mode, the draft reports for the patients or subjects are presented to the physician or an assisting staff person, to review and edit the reports and finalize the reports for ultimate disposition, such as storage in a document management system or paper file when the report is destined for a local file or local user, or by transmission or mailing to another party, for example as a report to the patient or to a referring physician or institution.

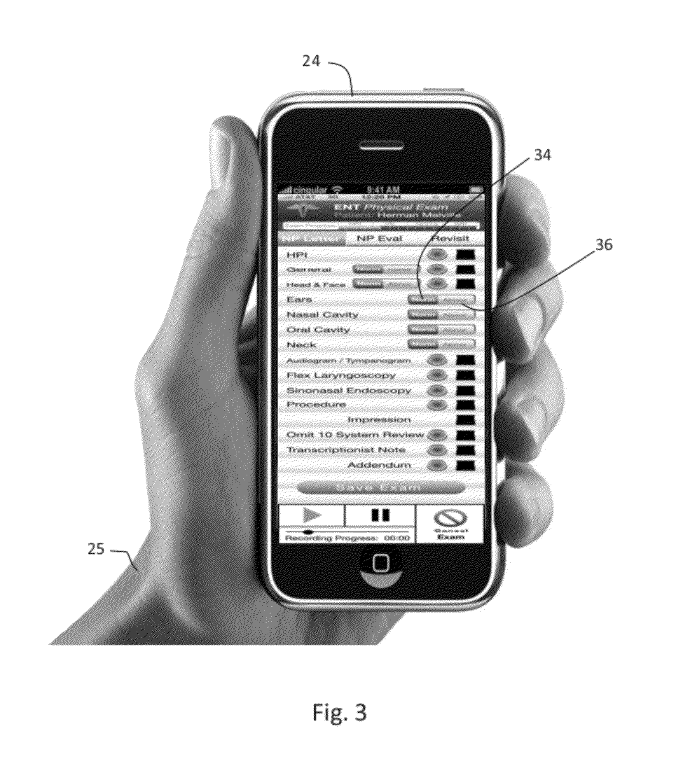

As shown in FIG. 3, the terminal 24 for interfacing with the physician can be a handheld terminal such as a smart phone. The programming presenting menus and recording selections in that case can be operated as an application on the smart phone operating system. Examples of such terminals include the Apple I-Phone, Motorola Droid, RIM Blackberry, Samsung Galaxy and others. Such devices are typically configured for audio input/output as necessary for use as a telephone and thus are adaptable as audio segment recorders whereby a narrative can be dictated by the physician or other operator. This audio is digitized, optionally compressed and stored. Either routinely or when selected, the audio is speech-to-text converted using speech recognition software, the text output of which is saved for insertion into the report.

The data from the patient encounter as reported from terminal 24 to the processor 26 (see FIG. 2), may include sufficient data to populate the report. Preferably, the data reported from terminal 24 does not contain all the necessary data but does contain identification or addressing information from which the report can be populated. Thus, for example, some of the patient's identifying or descriptive data may be looked up in a patient information database or otherwise using coding contained in the transmission from the data terminal 24, as opposed to being contained complete in the data from terminal 24. Likewise, the particular prompting and workflow categories that were presented to the physician are identified by codes in the transmission from terminal 24 as opposed to being fully embodied in the transmission. The transcription and assembly module 44 can produce a draft report by assembling segments for the report from one or several sources. The draft reports are then made available for review and editing, for example over a terminal such as terminal 35 in FIG. 1, configured for word processing, insertion of graphics and for ultimate production of the report.

In the embodiments discussed, the data processing system for use in assembling reports of procedures is exemplified by medical procedures. It would be possible to apply the inventive techniques to other procedures as well, such as maintenance of vehicles, documentation of transactions that have variable terms, and other situations requiring an attendant or practitioner to enter data that is used to produce a report in written or stored data format. Accordingly, the subject at issue may be a human with a medical examination or procedure, an inanimate physical item such as a machine, or a situation such as a negotiated deal or the like. In the embodiments discussed as examples, the procedures include one of a test and an examination procedure involving a human subject, which should be regarded as non-limiting as to the nature of the subject.

In an exemplary arrangement of data processing elements, the system includes modules that are supported on multiple servers or terminal devices containing processors. These modules can include a subject encounter and data collection module, a transcription and assembly module and a review and editing module. The subject encounter module is operable under control of programming operable on one or more of the servers or terminal devices and enables and optionally guides and prompts the practitioner to collect and accumulate selections made among alternatives offered, or data fields that are entered in response to a query, either for inclusion directly as strings or values in a report or as input data that is processed to produce a corresponding selection among alternative values or strings stored in memory.

According to one aspect, at least one narrative can be entered by the practitioner, for one or more of the successive subjects that are brought to the attention of the practitioner over a period of time, such as a working shift or span thereof. This narrative is transcribed and assembled with values that are looked up in memory or generated as a result of alternative selections to produce the output report.

The transcription and assembly module handling this part of the process is operable under control of the programming to select segments from text stored in memory. The memory stored segments are associated with the selections and are merged and concatenated with the narrative into sections of the report for each of the subjects. In one embodiment, the data entry for the narrative is dictated by the practitioner and transcribed to text data by a speech recognition program such as a Dragon speech-to-text product, either incorporated into or operated in association with the transcription and assembly module. As an output, the report can be stored, printed, transmitted, played back or presented in another manner, these outputs collectively represented by printer 37 in FIG. 1.

A review and editing module enables the practitioner, or optionally an assistant of the practitioner, to examine and revise the transcribed output from the transcription and assembly module. At least the transcribed narrative is reviewed and revised if necessary. Alternatively or additionally, a draft final report that includes the narrative (merged into the body of the report) and also including predetermined stored text associated with the selections made by the practitioner, for reviewing, editing and finalizing the report. The review and editing process is a batch mode operation in which the accumulated data for a succession of subject encounters are selected or queued up for review and editing. Preferably, the practitioner proceeds through subject encounters for a time during which selections are made and a narrative is dictated for the subject encounter, either concurrently with the subject encounter or shortly thereafter (e.g., before a next subject encounter is commenced). Then after a time, such as during breaks in a schedule of appointments or at the end of a work day, the practitioner or an assistant undertakes the review, editing and finalizing of reports for the day's encounters, or at least a selected subset of them.

In the example of medical procedures, such as medical examinations for checkups or diagnoses, and/or medical procedures such as treatments, surgeries, etc., the practitioner is an attending physician or a staff person associated with the physician or medical practice, such as a nurse, medical technician or assistant. The subject is one of a succession of patients attended by the physician or others associated with the medical practice during a work day or shift.

For example, in conjunction with testing, the practitioner might have any of various functions where a report is apt as a regular or as an occasional requirement. The practitioner could be a doctor, a therapist, an X-ray technician, a phlebotomist taking blood or fluid samples, a dialysis operator or the like. It is also possible that an encounter may involve two or more practitioners, such as a physician and also others who share some of the data input steps leading to one or more reports. Advantageously, for example, medical background information needed to compose a report may be obtained in part from a telephone or office conference with the subject in a preliminary interview or from a questionnaire handled prior to the subject's encounter with the physician.

Typically, the process that will be subject to reporting proceeds according to a predetermined model wherein certain diagnostic and/or conventional treatment steps are routinely undertaken and certain questions are routinely asked. For example, body temperature and blood pressure are routinely measured in connection with diagnostic procedures. Depending on the subject's presentation (e.g., the subject's symptoms and complaints or other statements), the practitioner may proceed according to one or another routine series of inquiries, tests and procedures. It will be assumed for purposes of illustration that the steps include at least one of examination of the patient, diagnosis of a condition, and treatment. The specific regimen chosen can be a choice of the practitioner or can be determined in part by information entered by the practitioner into a data terminal and/or information communicated from the database to the data terminal for prompting the physician to proceed in a predetermined sequence of queries and responses or tests and operations. The predetermined sequence may have an order or not, and may have a minimum set of operations or not, depending on the situation and the configuration of the system.

In an advantageous arrangement, the interface between the practitioner and the data processing systems includes an input/output device that facilitates collecting both data values and free form narrative text. A desktop terminal such as terminal 35 in FIG. 1 with a display screen and keyboard might be configured for this purpose. Advantageously, however, the input/output device forming the user interface for the practitioner comprises a wireless terminal 24, such as a web-enabled smart phone having a display screen, keys and/or a touch screen for data entry and an audio input for receiving dictation. Based on the nature of the subject encounter, and preferably as communicated to the terminal 24 over the network 30, a menu or sequence of menus are presented to the practitioner on the terminal 24. The practitioner enters information responsive to prompts presented on terminal 24. Typically, the prompts seek information obtained by asking, observing or testing the subject. The prompts are helpful, for example, to determine the subject's history, current state and needs and depending on the practitioner's practice might inquire about condition, symptoms, pains, functionality of organs, etc., in the same way that a practitioner such as a doctor might traditionally interview a patient. However unlike traditional operations, the practitioner is offered a specific set of data input alternatives.

A list of categories for inquiry can be predetermined and stored. This list can concern a discrete set of inquiries that are addressed in the subject encounter, or the list can include a set of starting inquiries, the responses to which are employed in the programming of the system either to trigger or to pass over the presentation of further inquiries in a conditional branching manner.

According to one aspect, one or more categories of inquiry that lead to the presentation of information describing at least certain subject attributes and/or report topics are presented as a text inquiry with alternative check box or buttons for recording a selection to be reported to the processor. The selections can include a “normal” response for a category or attribute by which the practitioner records that the state of the subject in the corresponding category of inquiry is nominal. The specific terminology for such indication can vary, for example to record a positive response to a prompt the subject's attribute is nominal, okay, satisfactory, acceptable or tolerable, within an expected range, etc. An alternative is to select a check box or button for recording that the state of the subject in the corresponding category of inquiry is not nominal or acceptable, etc., but instead is remarkable in some way. Typically this category is selected when the subject's state is deficient or of concern, but it would also be possible to use the category to indicate an especially favorable or salutary aspect that is to be noted in the report.

Each selection of a nominal or acceptable response can have an associated pre-stored text string explaining more particularly what is meant by an indication that the particular category is nominal or acceptable. The pre-stored text can be selected from the processor memory and incorporated into the generated report of the subject encounter. According to an alternative embodiment, although a practitioner may choose to identify a category or attribute as nominal or acceptable, the practitioner likewise can be offered a choice on the data input terminal as to whether or not the pre-stored text will be copied into the report. If the practitioner chooses to bypass the pre-stored text, the report can simply be silent about that category or can simply list the category title without any text expounding on the indication that the category was considered nominal or acceptable.

If a category is indicated as not normal, nominal, okay, acceptable, etc., the programming can continue to prompt with additional inquiries intended to narrow down the nature of the abnormality. Either upon the first indication of an abnormality or attribute that is noteworthy for some reason, the terminal devices is programmed to receive from the practitioner a text explanation, preferably narrated into an audio input. The text explanation, transcribed to text data if narrated aurally, is reproduced in the report.

Accordingly, the data processing system for assembling reports of procedures presents points for selection by or on behalf of the practitioner, which points enable optional selection of an input datum representing that the subject is nominal in some attribute or category and at least one optional selection of an input datum representing that the attribute or category is remarkable and is to be addressed by comments in a narrative. In the alternatives, either the selection of “nominal” for a category evokes a predetermined report segment defining or explaining what is meant by nominal, or is capable, by further input from the practitioner, to omit such a definition or explanation.

It can be appreciated that part of the nature of the system is to generate reports containing information that is dictated or entered by the practitioner when dealing with remarkable aspects of the subject, which typically are functional deficiencies, disease or pathological conditions and the like but also might be remarkably favorable, such as unexpectedly quick healing of a wound or other improvement. However, an important aspect is that the practitioner is expected or required to dictate or otherwise expound in the report or output on categories or attributes that are remarkable. The practitioner can attend to such dictation or expounding directly at the same terminal device 24 that is also capable of recording a datum indicating that a category or attribute is nominal, and optionally can record a selection that will produce an explanation as to the normal/nominal category, but that does not require the practitioner to compose a free form dictation or discussion for that normal/nominal category.

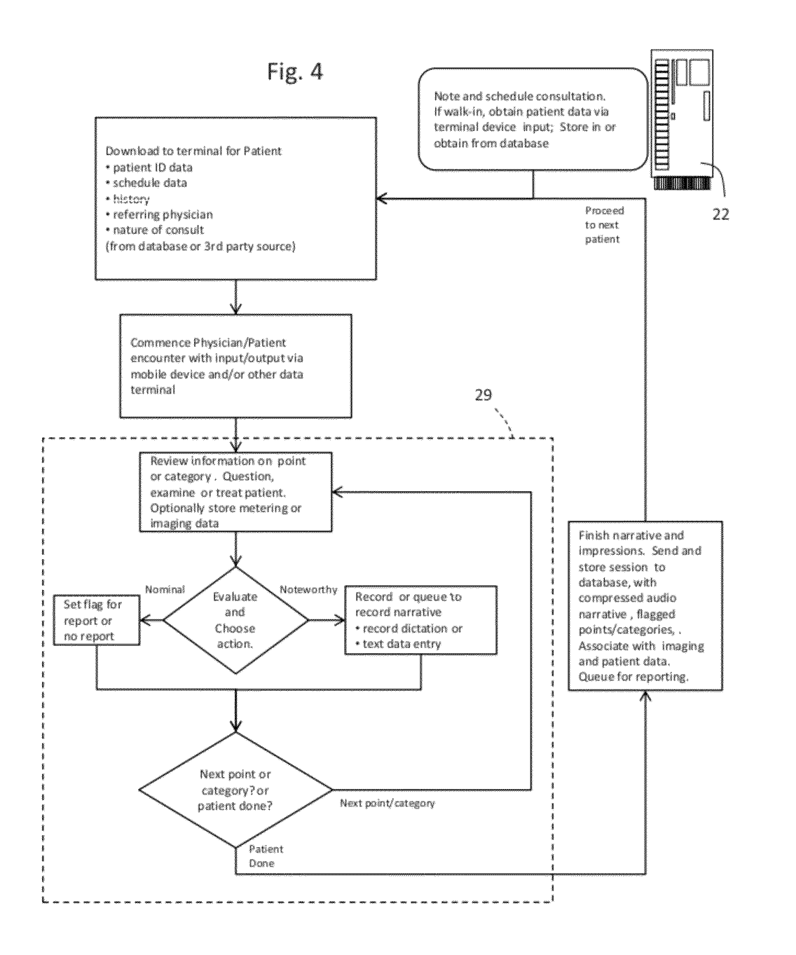

The system as described entails the hardware elements shown generally in FIG. 1, preferably configured with modular process elements running on particular servers, work stations or terminals as shown in FIG. 2, and arranged to accomplish a series of functions that are detailed in the flowcharting of FIGS. 4-6. FIG. 2 generally demonstrates separate workflow and data processing elements for a patient encounter module 42, a draft report assembly module 44 and a report review/revision and production module 48.

FIG. 4 shows aspects that are generally associated with the practitioner's encounter with the subject as in block 42 of FIG. 2. The identity of the subject and the reason for the subject's visit are generally provided from one or more of the data processing systems associated with the system, such as a patient data and appointments processor 22. The patient identification and scheduling information are provided for download or are made accessible by suitable input/output communications between processor 22 and the practitioner interface processor such as the handheld wireless smart phone unit 24. Also made available or downloaded is an interactive menu having a set of topics or categories that are addressed, selected according to the reason for the subject's visit and intended to address some or all of the matters to which attention is directed by the subject and the practitioner, and some or all of the matters that are to be representing in the output, preferably including a transmitted report but at least including a report of stored information memorializing the visit.

The topics are addressed as presented on the interface unit 24, and can be handled sequentially or in any order desired. The topics may vary according to the situation but for purposes of illustration might for example include general inquires about health and any complaints, an examination of anatomical systems, a report of any procedures undertaken, and the practitioner's impressions. Referring to block 29 in FIG. 4, some or all of the topics prompt the practitioner to select a normal box 34 or abnormal box 36. The abnormal selections signal an expectation of additional free form information, typically entered by dictation directly into the unit 24 immediately after the patient visit. The information is stored and used to provide the basis for generation of the report.

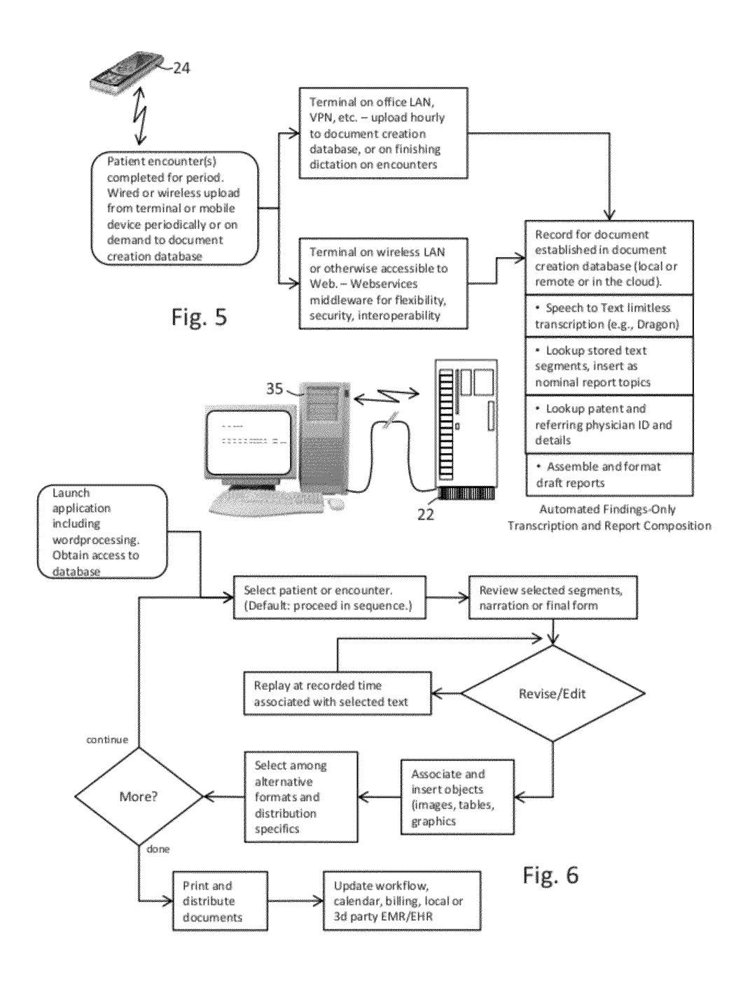

In FIG. 5, the narrated part of the report is transcribed to text data and the selections that were entered by the practitioner, such as responses indicating that a physical system is normal, signal the data processing system to produce text that is not dictated but instead is looked up in the pre-stored information as a representation of what “normal” should be construed to entail. The same description can be displayed on practitioner interface unit 24 in association with the selection of normal and abnormal, thus inducing the practitioner to consider the aspects that will be reported using the pre-stored information. In any event, patient information including identification, address, age, stored medical history, referral source and the like are available through the patient scheduling database. The topics and reports, including free form dictation are available from the practitioner interface unit 24. Additional information including pre-stored text and formatting are likewise available from the various processors and servers, including by communications over the network 30 (see FIG. 1). Accordingly, the information that is necessary and desirable is all at hand for assembling at least one report, and preferably for assembling one or more selected reports from any of several alternative formats at least partly associated with the practitioner/subject encounter. In FIG. 6, an operator such as the same attending physician practitioner or an assistant, logs into the system, preferably after appointment hours, selects subject encounters to report and formats for the reports, and proceeds to generate the reports by selecting a format and reviewing and revising the report that has been assembled automatically by the system from a collection of stored and narrated information.

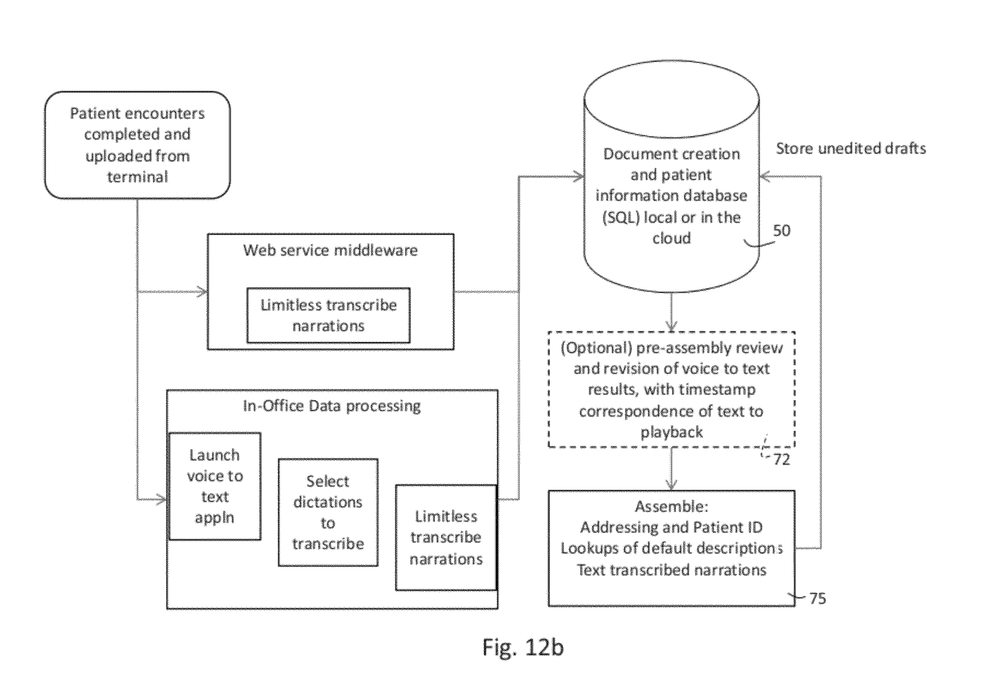

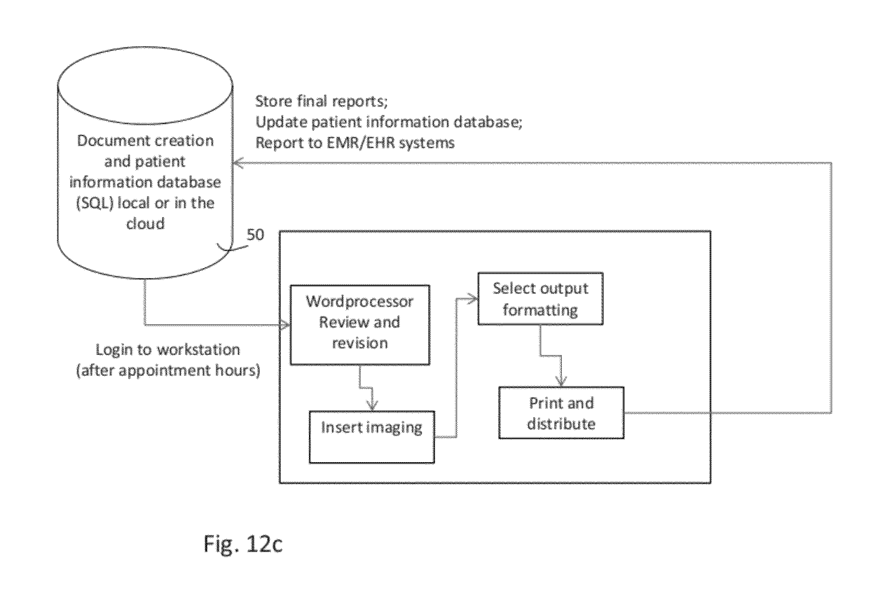

FIGS. 4-6 are generalized flowcharts showing operations and functions in blocks that are more specifically described below with respect to FIGS. 12a through 12c.

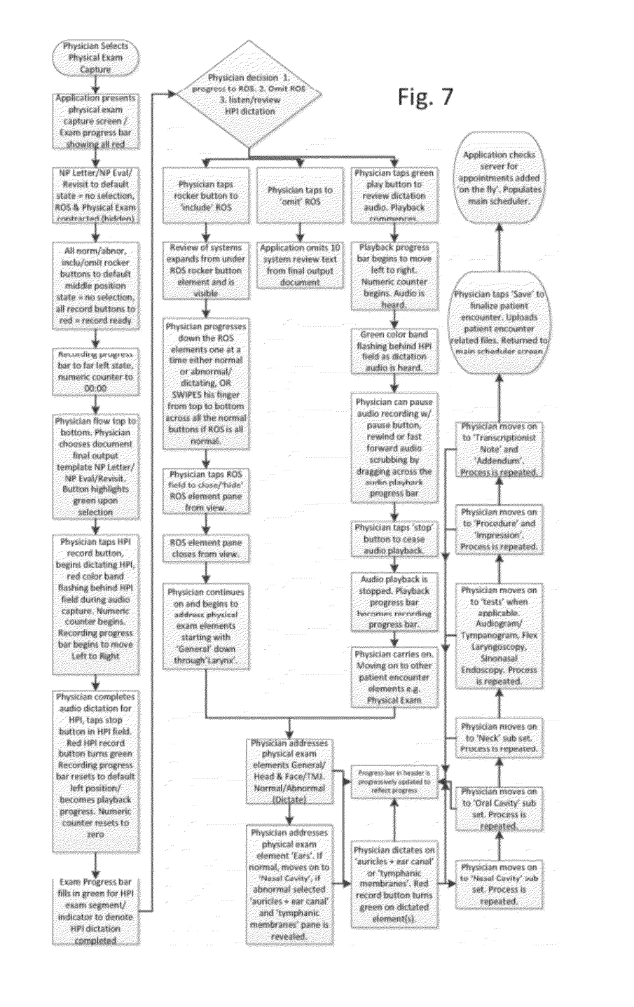

According to an advantageous aspect, the physician's interface terminal 24 comprises a smart phone, and in particular can be served by one or more applications operating on a smart phone. FIG. 7 is a flowchart demonstrating aspects of the programming of a representative example, wherein the application is arranged for an otolaryngology examination. Having been queued from the patient information and scheduling processor to conduct such an examination on a given patient at a given time, the terminal 24 is arranged to produce a display such as that shown in FIG. 3, wherein the categories are represented. Input selection areas or pads (sometimes known as CGI boxes) are available for selection by point and cock or by touch screen operations. Pads or buttons are operated by the practitioner to select categories, to flag a category as done, and can invoke informational displays. Selections enable the practitioner to mark categories using the normal 34 or abnormal 36 selections.

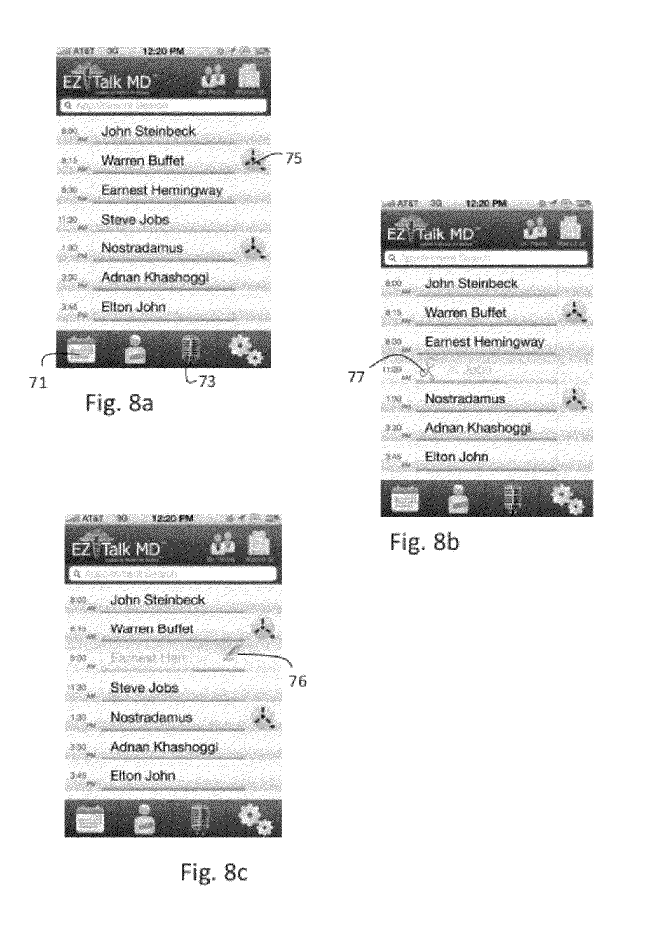

The same practitioner interface unit 24 can be used as a patient scheduling and workflow management unit, examples of such functions being shown by FIGS. 8a through 8c. In cooperation with the scheduling processor 22, a list of appointments are displayed, including names and times. By selecting a name (e.g., by touch screen or point and click), background information can be called up for display. Prior to an encounter, the background information may be limited, for example identifying only the patient name and the reason for a visit. Instead of an hour-by-hour display, selection of a calendar icon 71 can be used to select a different day. In connection with practitioners having multiple offices, the calendar function can be used to notify the practitioner in advance as to the office location where the practitioner is expected to appear, e.g., using labels or color coding on calendar blocks for selected days or hours.

As already described, the practitioner makes selections and enters dictation in association with subject encounters. Whereas the dictation is normally entered after the face-to-face visit, the display as shown in FIGS. 8a-8c can include icons showing for example by an icon 75 (a tape reel icon) that a dictation has been completed or an icon 76 (a writing quill) that dictation is expected. By selecting a subject name and an icon 73 (representing a microphone), the unit can be switched into a dictation mode reverting to the patient encounter screen (FIG. 3) and enabling dictation into categories that are required and preferably are flagged on the screen as needing attention or as already done. Referring again to FIG. 8b, other icons are also useful, such as an icon 77 (showing a stethoscope) to flag the name of a current subject or perhaps for another reason such as to remind the physician to collect information such as heart rate and blood pressure readings. All such information is recorded to document the subject encounter, both during the encounter and afterward.

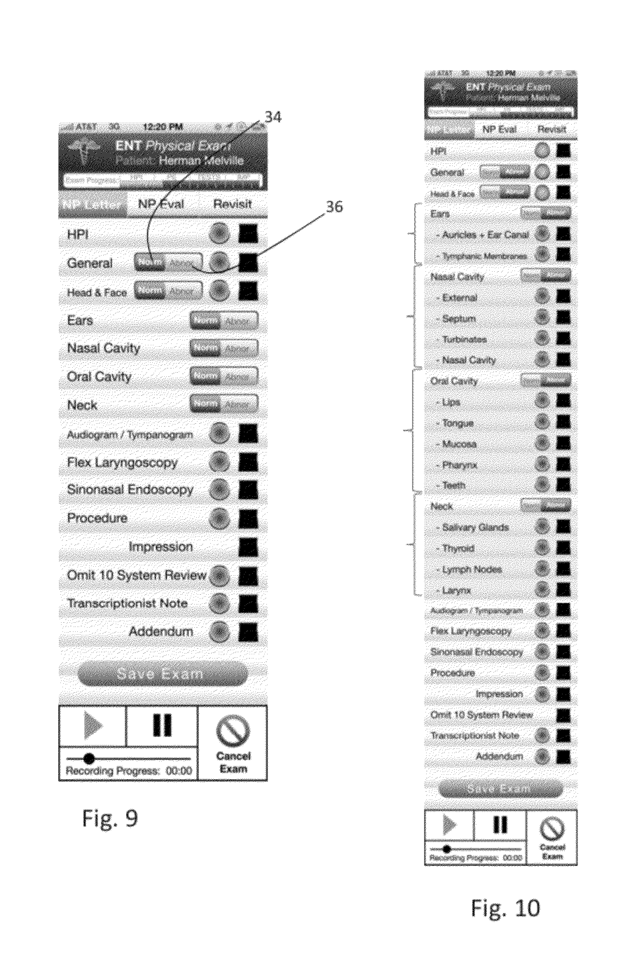

FIGS. 9 and 10 demonstrate a practical otolaryngology application. In FIG. 9, the examination topics are shown, some of which have normal/abnormal selection options 34/36, others having (e.g., HPI) for simply marking that the subject has been addressed, one (impression) being adapted for a summation by the practitioner. In one embodiment, categories with normal/abnormal selections appear normally, as shown in FIG. 9. The sub-categories and/or attributes within the categories can be normally hidden on the examination menu display screen. However, if the user selects ‘abnormal’ (or a similar designation) for a general or prominent body system heading or grouping, the menu can be expanded as shown in FIG. 10 to present the sub-categories, such as additional menu items for anatomical parts of the general or prominent body system. If a general body system appears nominal, there may be no need to delve into the nominal state of the subsystems. Alternatively, the physician might also wish to comment on one or more subsystems, and this can be accommodated, for example by causing selection of the general system to expand to also show the subsystems (all shown expanded in FIG. 10).

In a ‘normal’ selection state for a prominent body system, all of the pre-defined corresponding ‘normal’ verbiage content for all of the subsystems can be automatically selected and automatically populated into the appropriate fields in the final output document of choice. Alternatively, mention of particular subsystems can be marked for omission. If all the subsystems are marked for omission, the report can be provided with a synopsis for noting that the general system was nominal or unremarkable.

Because subsystem menu elements are normally hidden (not shown unless an abnormal finding is selected), the number of lines on the examination menu screen is limited to what is needed. In a list format, the user can typically complete an examination without extensive scrolling of the display up and down to display and attend to all necessary lines.

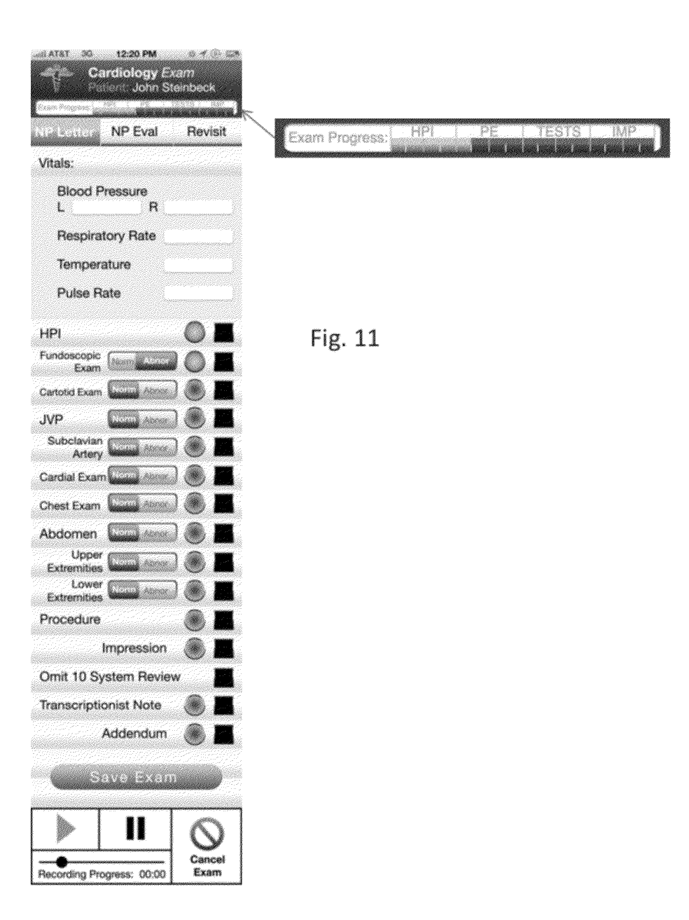

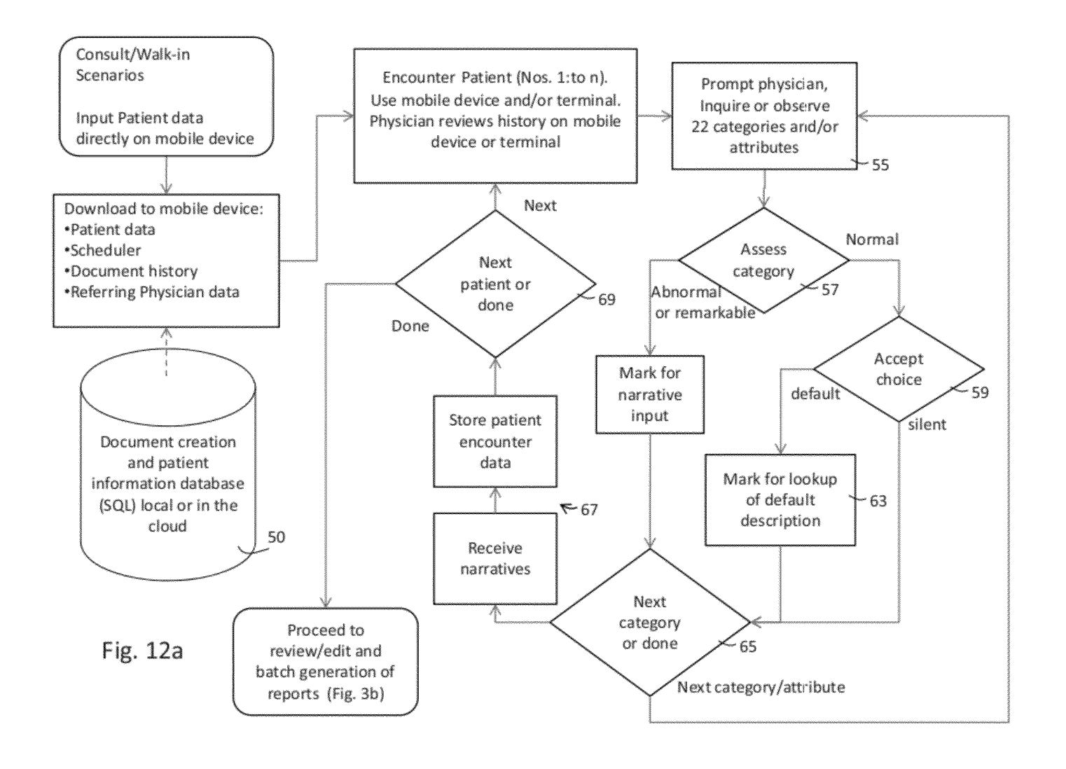

FIG. 11 shows an example of how the contents of the screen and menus associated with the screen of practitioner interface wireless unit 24 can be customized for a particular practice. In FIG. 11, the practice is cardiology. Boxes are provided for entering numerical data in fields of a predetermined number of characters, similar to entry of data into a form. In other respects, however, the screen is as already described. A set of categories are provided, in this case of interest for cardiology. The categories optionally are expandable in a manner similar to the expansion in FIG. 10 of categories found in FIG. 9. Check boxes for recording the completion of a category or for managing the submission of dictation for a category are likewise provided. This view also shows a blowup of the “exam progress” status bar and an expansion of the microphone icon into dictation controls for forward/rewind (shown in the forward state), pause, cancel and a timer value.

In FIGS. 12a through 12c, the source of patient information, which can also be the source of appointment data, the data storage arrangements, and one destination for the output data, is a database 50, such as a structured query language (SQL) database that contain relationally linked fields associated with the subjects or patients, the practitioners or physicians, both referring and attending, the subject encounters, the potential patient conditions and associated workflows and generally all the data variables to be stored and associated variable values. As mentioned, the respective parts of the database need not all be localized in a single unit, and values of variables can be stored in one or another of these devices, all of which can be in data communication as shown in FIG. 1, and made available by suitable queries to the other servers, processors, etc. In FIG. 12a, patient encounter arrangements begin with making appointment scheduling, patient information (e.g., history, referral information, etc.) available from the database to the terminal to be employed by the practitioner (e.g., attending physician) in connection with the encounter, such as mobile terminal 24.

When the practitioner encounters a first patient (no. 1), the downloaded information is made available to the physician on the terminal (such as mobile wireless terminal 24), together with a menu of choices that prompt the physician to proceed through predetermined inquiries or steps. For example, if a physician is a ear/nose/throat specialist and the patient has complained of sore throat, the physician's routine might inquire as to body temperature, appearance of tissues, swelling of glands, etc., in categories and in attributes within categories, are each prompted for assessment. Preferably these categories include default categories and attributes, and also permit a physician to customize categories and attributes for a particular practice. The physician proceeds through the categories (blocks 55-67), assessing each category. The physician can enter data for particular categories requiring a number or a text string input, but for at least some of the categories, the physician determines (at branching block 57) whether an attribute or a general category is normal or not. If normal, the attribute can optionally (at block 59) be marked to be reported with a predetermined description of a “normal” result (block 63) or can be marked to be passed over.

Insofar as a category or attribute is accorded an abnormal or remarkable assessment by the physician (block 57), that category or attribute is noted to be due for a narrative description (block 61). The narrative can be entered immediately, preferably by dictation received and recorded by the wireless terminal 24, but it is normally preferred as better manners to dictate a narrative on each required category or attribute after concluding the encounter with the patient but preferably very soon after the encounter. In that event, the categories that are to have a narrative are marked. The encounter proceeds to the next category (back to block 55). After addressing the list of categories, the results are stored for the patient. At some point, preferably shortly after the encounter, the categories marked for a narrative are displayed as reminders and the physician is invited to dictate a description, impressions, prognoses and other pertinent comments, which also are stored, for example in compressed digital audio data form. At this point (block 67), the patient encounter is complete and the necessary information upon which to base a report has been duly stored, at least in digital coding.

The list of categories/attributes which can be a short or long depending on the patient's presentation and the physician's practice. Also, the progress through the categories/attributes can be static and predetermined, or can be variable, for example arranged in a branching manner so that certain selections of normal/abnormal reporting may or may not introduce additional categories and attributes to be addressed. Optionally, and in particular for certain regularly encountered maladies, the organization of the attributes can be arranged to effect a diagnosis.

The physician proceeds to a next appointment if scheduled, likewise encountering the next patient, whereupon a set of inquiries applicable to the next patient are presented, assessments and decisions are made and data or narrations are stored. The particular list of categories/attributes addressed normally vary from patient to patient, but successive patients of similar situation may be encountered presenting similar symptoms from time to time. In any event, the physician proceeds through his or her appointments accumulating information in this manner. When a grouping of patient encounters is completed (such as at the end of a morning or at the end of day, at block 69), the physician can proceed to handle the generation of reports in a batch process wherein any number of encounters and any number of descriptions and/or dictations or any number of bytes for a given dictation, can be assembled into a report. This process is shown in FIG. 12b.

FIG. 12b demonstrates that data from patient encounters that is uploaded, for example, as shown by block 67 in FIGS. 12a and 12b, can be processed as an in-house operation running on one or more of the terminals or servers 22, 24, 26, 35 or can be processed through middleware to a web service. Likewise, all or part of the transcription from speech to text may be accomplished on the terminal 24 used to record the text. The transcribed narrations and also any entered data values and all selections among alternatives entered by the physician (or associated practitioner) are stored in the database 50.

As an optional matter (block 72), the narration and speech-to-text transcription can be reviewed before assembly into a draft report. This step enables the practitioner to preliminarily correct errors and is especially useful if accomplished soon after the narration has been recorded. According to one aspect, this step can be accomplished on the mobile device 24. Alternatively, the practitioner or an assistant can log into an associated terminal such as desktop terminal 35, and edit the narration. According to another aspect, the narration text can be time stamped to correspond to time points in a recorded audio, and the device 24 or 35 can selectively be caused to playback the audio that is associated with a particular place in the text transcription.

When the text narration(s) are available, a programmed processor operating in one or more of the servers, workstations or terminals assembles the elements of a draft report (block 75). The process obtains names and addressing information from the database 50, which values have been associated with the subject and the appointed encounter. The process has a format that is associated with the reason for the subject encounter, such as an examination, diagnosis, treatment process or the like, and that reason generates information associated with each of the selections that were offered to the practitioner and each of the options that were selected. The information also includes the narrative dictated text.

The form of the draft report is assembled from these data values and stored in the database 50 for final review and editing using a programmed word processor function, shown in FIG. 12c. The report has a format associated with the reason for the patient encounter, or preferably has a plurality of alternative formats that can be selected. These include a letter to a referring physician reporting on a patient encounter; a memo to file for future reference by an attending physician or associated practitioner; a letter to the subject confirming what transpired and perhaps documenting instructions and recommendations; a form invoice to an insurance carrier; a letter to an employer or institution certifying to fitness or perhaps certifying a condition of disability; and so forth. Preferably, all such formats are available. However either the particular desired format is predetermined from the patient data or patient encounter data, or the desired format is selected when producing final reports as shown in FIG. 12c.

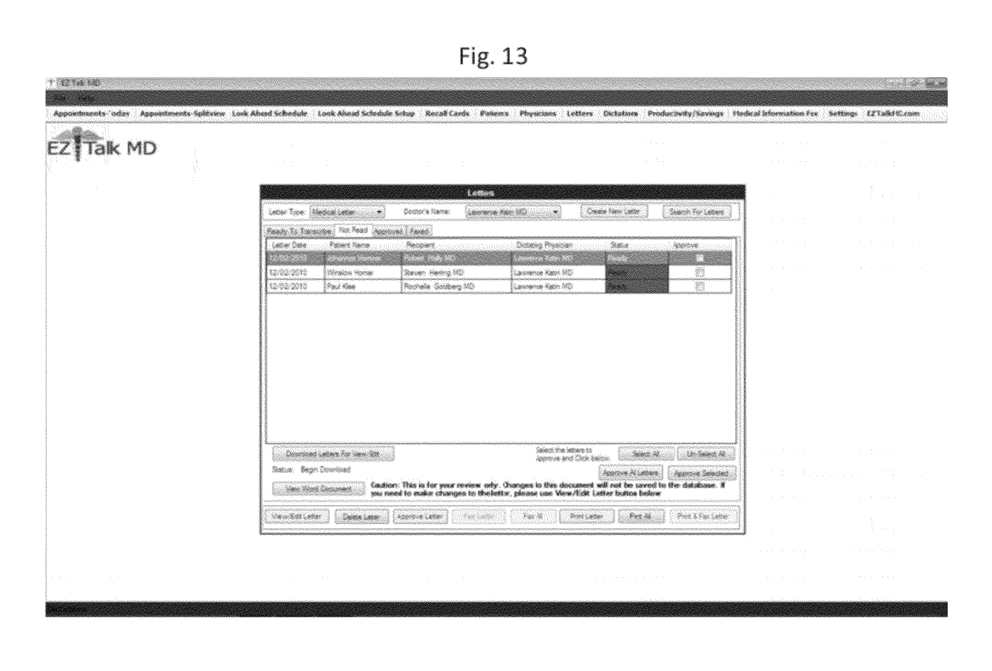

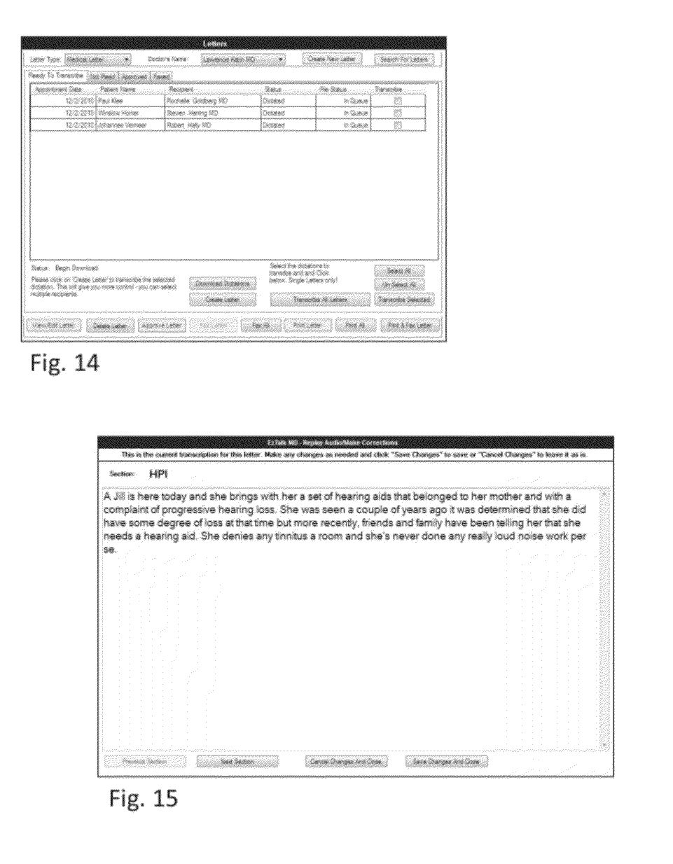

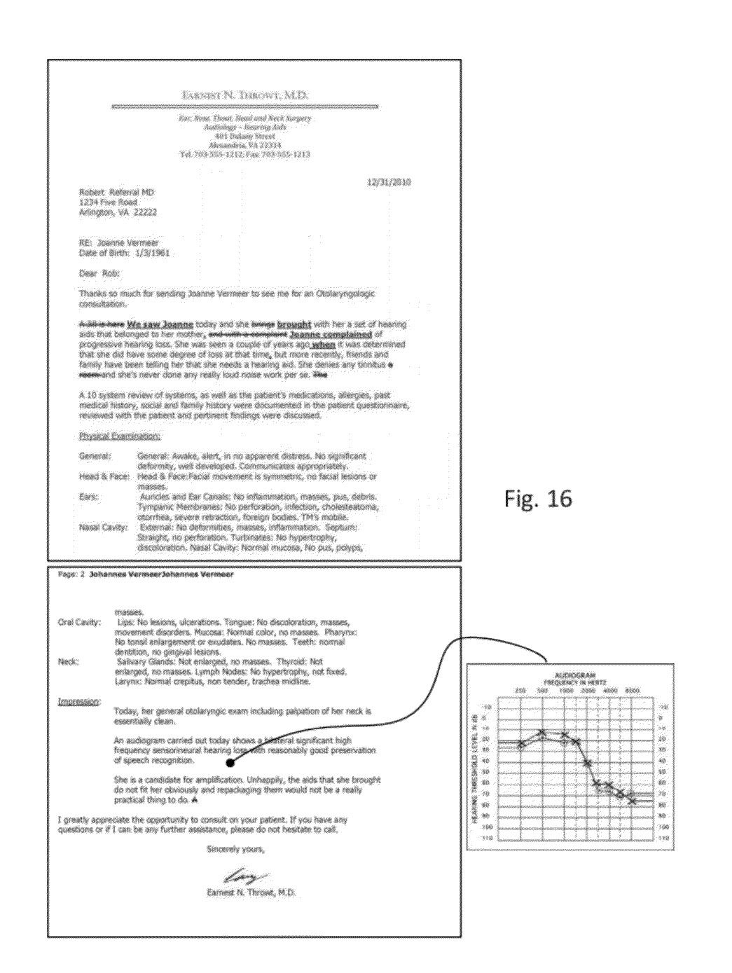

In a typical embodiment, the practitioner or an assistant logs onto the networked computer system to produce reports from the selections, data and narrations that were entered during subject encounters, for example using a desktop terminal 35 coupled to a printer 37 (FIG. 1). A display screen may be presented as in FIG. 13, enabling the review of a subject encounter record. The review may involve selection of a single narration as in FIG. 14, displayed as in FIG. 15, or selection of a draft document incorporating a narration as well as other text. FIG. 16 shows one possible format for a report, in this case a letter reporting to a referring physician. Edits accomplished when reviewing the document are shown in typical word processor forma. Notably and as shown in FIG. 16, there are elements in the report including the address and subject line that are obtained from the patient information database, preferably also some fields such as a date of birth or the like that are lookup values taken from the patient information database. Part of the text of the report explains the reason for the patient visit and the nature of the patient's complaint (in this case asking to have her hearing tested and possibly obtaining a hearing aid). The report includes under “Physical Examination” some text fields that were generated from selection of “normal” in response to category and/or attribute queries wherein the practitioner observed simply that the general state, head and face, ears, nasal cavity, oral cavity and neck appeared to be “normal.” The report recites the pre-stored definition of a normal state. However the report contains a narrated report of the “impressions,” wherein the physician's impressions are set forth in descriptive text that was dictated, transcribed (preferably by speech to text software), reviewed and edited.

The report can have custom narrations, and looked-up pre-stored selected passages as shown. As also shown in FIG. 16, the report can include other objects such as graphic depictions (e.g., X-ray prints), tabular data or graphs. The example shows an audiogram test result graph demonstrating the subject's high frequency hearing loss as also demonstrated in the preliminary reasons for the visit and in the physician's impressions.

As a computerized method for composing reports of procedures involving subjects, the technique as shown includes providing one or more data terminals, processors and/or servers for operation by an operator (up to now identified as the practitioner, such as a physician or assistant). At least one data terminal 24 is controlled by programming for prompting the operator to choose among input selections, and additionally accepting from the operator at least one narrative responsive to said prompting, wherein the input selections and the narrative relate to at least one of a subject and a process involving the subject. The choices made by the operator responsive to the prompting, and also the narrative, are communicated to a programmed processor coupled to a database. The narrative can be communicated and stored as either/both an audio recording before transcription or/and as a text file after transcription.

Based on the selections made by the operator, the programmed processor chooses among a plurality of pre-stored text segments corresponding to the selections, composing a draft report. The text segments selected by the processor are associated with the choices made by the operator, for example, in that if the operator selects an input option to indicate that an observed condition of the patient is normal or nominal, the corresponding text segment can explain what is regarded as normal or nominal. In the case of a body temperature, for example, the selection of normal/nominal could recite that the patient's body temperature was measured orally and found to be 98.2±1.3° F., or in a simpler example, the recital could be simply that the observed temperature was normal. In the case of a patient presenting a pathological condition, the operator might choose abnormal, state the body temperature and observe in a narration whether the temperature was or was not remarkably high or low given the patient's condition. More or less complicated examples will be apparent to those skilled in the art, who frequently encounter the same sorts of conditions in various subjects encountered.

The draft report is composed by interleaving and concatenating selected predetermined segments and narrated segments respecting those categories or attributes on which the practitioner or operator decided to comment. Preferably, the encounter has an associated menu of topics and categories that are routinely covered, and also provides for general purpose topics. The routinely associated topics can be organized with respect to a medical objective for a respective patient. The input selections offered for prompting can be categories that include a checklist of topics associated with the objective. This technique is useful not only to record information but also to better ensure that the examination or other procedure encompassed all the topics on the checklist.

After proceeding through a list of specific topics of interest (e.g., categories of information pertinent to a condition presented by the patient such as a disease condition, or pertinent to a specific procedure such as a physical examination for some particular purpose), the practitioner has an option to dictate a passage to be included in the report respecting general or specific impressions, comments, prognoses, recommendations or the like.

The data terminal is configured and the practitioner is able to accept, at least for at least certain prompts, alternative responses associated with a nominal reply and a noteworthy reply. The nominal reply may indicate a normal or healthy condition or may indicate a condition that is commonly encountered even if not normal or healthy (such as elevated body temperature or tissue inflammation that is normal or unremarkable when associated with an infection or a traumatic injury. Preferably, the practitioner is not absolutely required to adopt and to insert into the report the pre-stored description of the normal condition. In one embodiment, the data terminal is configured to accept an input for selecting whether or not at least one normal or nominal reply will be reported or omitted from the report. Preferably, the practitioner is expected to dictate a freeform narrative comment with one or more of categories that are selected to be abnormal or otherwise noteworthy, but it is also possible to enable the practitioner to omit that dictation as well.

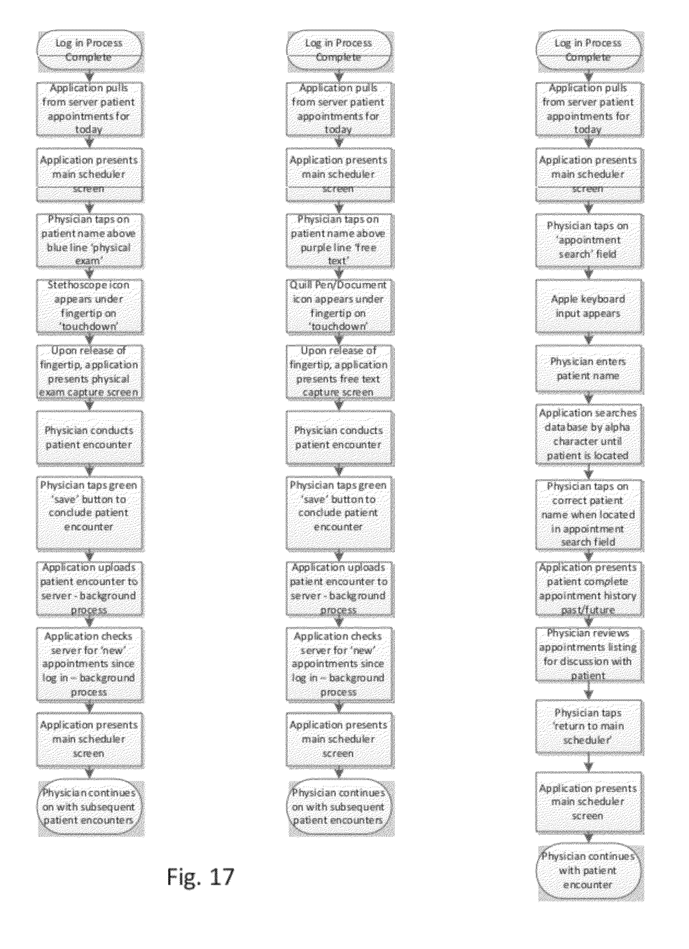

The disclosed system has calendar management, workflow management, quality assurance, report generation and automatic health management information aspects. These benefits are provided by network access to the servers and database of information as shown, using web-enabled wireless terminal 24. As shown in FIG. 17, the device is adapted for additional functions at the same time, such as the scheduling of appointments and managing time in respective offices. And of course, the same device is typically capable of other applications including cellular telephone access, instant messaging and email.

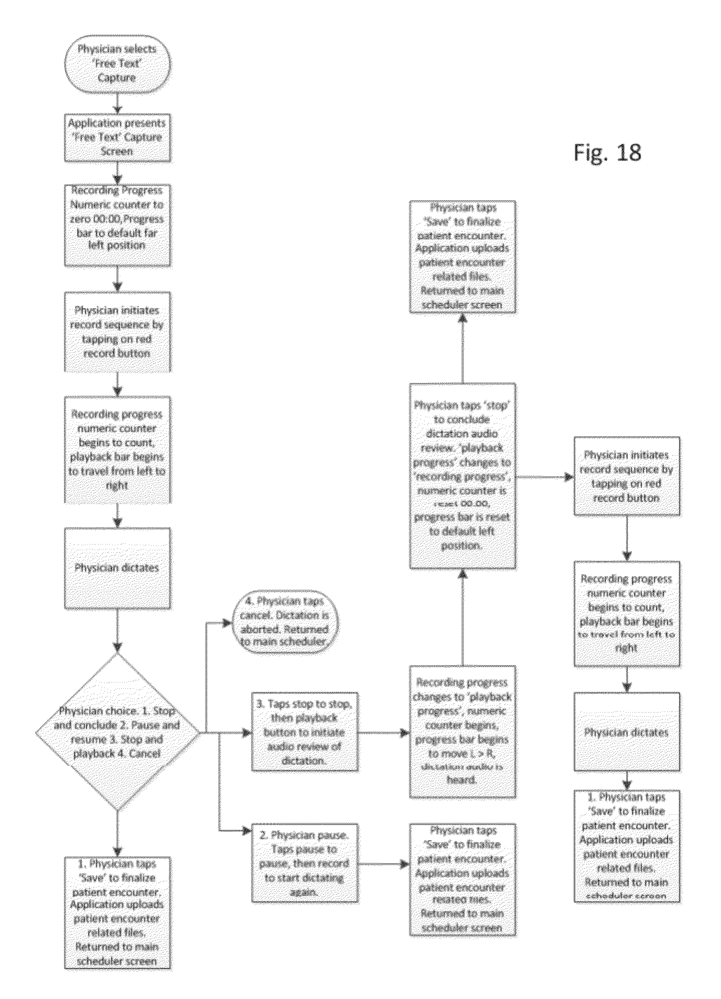

FIG. 18 demonstrates that free text entry operation of the physician/practitioner interface terminal, which can comprise, for example, a “smart” phone containing cellular telephone and wireless web-accessible data communication capabilities. In one embodiment, the terminal can comprise an Apple I-Phone with a touch screen for input/output, programmed such that the operator can touch the associated points on the display to input selections of menu buttons, to select boxes for text entry, to slide variable controls and the like. In FIG. 18, certain specific arrangements are shown as examples of program progression and operational steps.

The subject system has a number of salient aspects and capabilities enabled by configuring a network and a conveniently accessible terminal with access to the network, substantially as described. One aspect is and appointment and workflow management system that captures a record of a physical exam or procedure, segmented into topics. A further aspect is that the topics are restricted by pre-stored or predetermined reporting values or text only if so selected by the physician or other practitioner, and not with respect to topics that are considered abnormal or remarkable, which topics are subject to custom dictation. This technique permits a physician to record information quickly, completely and accurately.

The risk of misinterpretation by persons downstream of recordation of information is controlled because the physician can record impressions by his/her own dictation and replay them. The physician is not forced into reporting pigeon holes, namely forced to select only from predetermined selections and text, because aspects that are remarkable can be subject to a dictated comment that can be short but is also unlimited if a longer explanation is warranted. Although free to expound, the physician is nevertheless empowered to exploit sources of predetermined information when most appropriate, in particular when the patient's corresponding condition or attribute is found to be normal, nominal or unremarkable under the circumstances. Thus the physician is able to exploit but is not required to dictate or revise and correct portions of reports that might be regarded as boilerplate text.

Although the disclosed system software employs speech recognition software, the system is more than merely a computerized transcription system. Aspects of workflow management improve efficiency. Control of the progress of examinations by following pre-planned categories lead to completeness and accuracy of diagnosis. Data collection and report generation are efficient because appropriate sources of available information, appropriate use of simple selections among alternatives and also highly personalized and customized dictation are merged.

In an exemplary arrangement, about two dozen separate categories of inquiry are addressed in a menu driven sequence that is customized for a physician's practice. In that arrangement, it is possible to have two dozen distinct narrations per patient, regarding categories or attributes that are remarkable. In addition to customized narrations, the selections and available descriptive text selections encompass physical exam results by practice specialty group parameters, anatomical examinations and assessments, testing results, personal history information (HPI), physician impressions, documentation of procedures, transcriptionist notes, addendums and the like, to be automatically processed utilizing speech recognition processing technology. In a preferred arrangement, a dozen or more different output documents or formats can be selected for documenting the collected information. The system thus supports the generation of one or several reports that may contain different subsets of the collected information and are destined for the patient, a referring physician, the attending physician's files, insurers, institutions seeking assessments or test results, etc.

Advantageously, the database 50 comprises a relational database that stores data in variable fields associated with patients' encounters, but also can be expanded to comprise, or can be linked into a patient medical information database. Likewise, the system, particular embodied with an SQL database, can provide information supporting a physician practice management database, can draw from or feed information into scholarly medical information sources or medical standards databases, and generally can be configured to merge into various aspects of medical technology and practice.

The design of examination menus as discussed above can be customized for a practice specialty or for the preferences of a particular physician. The design of the examination menus alternatively can be standardized to meet physician advisory board specifications and best practices. The technique of providing menu driven normal/abnormal data capture distinctions (normal selections generating approved verbiage) is apt for application to any number of general and special medical practices. Surgical/specialty groups presently supported include the examples demonstrated, namely ENT (Ear, Nose and Throat) and Cardiology, as well as Urology, Orthopedics, Plastic Surgery and Ophthalmology. The technique is plainly applicable to other physician practice specialties and also to other areas such as EMT operations, general purpose screening by non-physicians, applications that are not medical per se, etc.

In connection with approved examination elements (categories address and selections offered), users can be permitted to select among more or less comprehensive menus of physical exam elements, testing elements, office downstream communication elements to which reports are directed, addendums, billing and coding protocols, and the like. Insofar as these elements are standardized or required by administrators or other, the menus employed can be changed or updated, or new menus distributed over the web or otherwise, for example to comply with changes in HIPAA regulations, insurance billing and coding protocols, changes or additions to a medical practice's office procedures and the like.

Although the disclosed technique is merged with technology, the activities of the participating physician are much the same as already developed through training and experience. The daily activities of meeting and examining patients, the assessment of conditions, impressions and diagnoses, treatment procedures and medication are all of the familiar sort. However the appointment process is automated and merged into a workflow including patient encounters, collection of information and recording results toward generating reports. But the appointment process is automated and coupled automatically to a smart phone or similar personally accessible terminal. The examination process has its familiar steps but is supported by added information and technology. With a few selections among categories and attributes made by the physician on the terminal, plus dictation of passages of customized text between patient encounters, a comprehensive record can be generated and exploited to produce many of the reports, memos and forms that are required to support a modern practice.

According to one aspect, the selection of “normal” findings for respective categories produces a report describing a description of normal characteristics in that category. The practitioner can instead select an “abnormal” finding in a category. When the category is a general anatomical system, the “abnormal” selection can invoke the subsystems of the general anatomical system, each likewise permitting a selection of abnormal or normal. When an “abnormal” finding is selected, either in a general category or an anatomical subsystem, the physician is given an opportunity to input a free form explanation. The physician selects a red ‘record’ button by pointing in and clicking or by tapping a touch screen at the indicated button, and then records a dictation concerning the ‘abnormal’ finding. The dictation is then transcribed downstream, preferably using a software speech-to-text routine, whereupon the dictation provides the content for a corresponding field in at least one formatted report that can be selected as the final output document. During the dictation recordation, the physician preferably has a displayed audio recording capture time meter and other audio recording transport functionality such as stop, pause, rewind, fast-forward and insert or punch-in.

In summation, the narrative capture physical exam, dictating on ‘positive’ or ‘abnormal’ findings only* case for uniqueness and non-obviousness in the marketplace. I submit the following bullets.

The ultimate report can comprise a customized hybrid of data entry values whether numeric or letter string and whether free form or otherwise, selections from yes/no alternatives, human narrative captures and the like. These different modes of input can be used as appropriate for particular specialty groups and might be used to enter vital signs values, medical history or family history responses, physical exam elements, physician impressions, test results, office communications and other data values.

The information that is entered in the manner described preferably is used not only to populate data values in reports. The information is also employed to update one or more local or remote medical information databases. In the exemplary embodiment, an SQL database is provided in data communication with other terminals and servers including the practitioner interface terminal and the report generation terminal. One or more SQL databases can be used for patient information, appointments, workflow management associated with preparation, patient encounter management (e.g., specifying the data entry categories associated with types of encounters), report generation and storage, reporting to multiple recipients, medication choices, prescriptions, billing, follow-up scheduling and other aspects of health maintenance. Among other tables and variables, the SQL database includes as primary tables

| | | |
|---|---|---|
| 1 | tblPatient | Patient demographics |
| 2 | tblAppointments | Appointment |
| 3 | tblDictations | Voice recordings |
| 4 | tblLetters | Letters/notes |
| 5 | tblLetterText | Transcribed Text |
| 6 | tblLetterSections | Used to track which |
| | | sections of the full physical |
| | | examination are dictated. |
| 7 | tblPhysicians | Referring Physicians |
| 8 | tblCCLetters | List of physicians/entities |
| | | that are cc'd on a letter |
| 9 | tblPractioners | Practitioners in the |
| | | clinic/facility |
| 10 | tblUsers | Authorized users of the |
| | | application |

Appropriate utility tables can include:

| | | |
|---|---|---|
| 1 | tblDeviceAuth | Authorized mobile devices |
| 2 | tblDeviceAuditLog | Log of all access requests |
| | | by mobile devices |
| 3 | tblCurLocationSettings | Color coding by |
| | | practitioner/location for |
| | | easy visualization of |
| | | schedule |
| 4 | tblCampaigns | Marketing campaigns |
| 5 | and others | |

In some encounter situations and medical specialties, a relatively small and finite set of diagnoses can be associated with selections, and a limited range of variable values, and a specialty physician may encounter such with some regularity. The subject system can benefit from practice redundancy. For example, frequently encountered situations can be modeled in the set of categories and aspects upon which the physician is queried to indicate normal and abnormal findings. The physician's narrations can matched to the vocabulary of terms associated with the condition, which produces a low rate of transcription errors.

In an assembled report or in the fields of a database variables are typically included for dates (e.g., previous visits, future appointments or follow-ups), patient name, address and demographic values (age, gender, etc.), referring physician information, formatting choices (e.g., letterhead, salutation, closing, signature line), normal and abnormal category entries, physician impressions/diagnoses/plans and similar values. By limiting the need for dictation and pre-storing some of the necessary choices and values, minimal corrections are typically required.

Although the practitioner interface terminal 24 has been discussed with respect to entering normal/abnormal findings during encounters and dictating narrations, the practitioner interface terminal, like the other terminals mentioned, also can be used to enter other information filling in the patient record or the encounter information and also furthering the generation of the output data or document. For example, the practitioner interface terminal can be used to enter data that might otherwise be available from the patient information database, such as entering data changes, e.g. changes of address and the like. The practitioner interface terminal can be used to review and approve the speech-to-text output when dictating. The physician or other operator can use the terminal to select output parameters, for example to select among multiple report types, to select among multiple possible recipients of a given report and so forth. Some possible examples of different report types that may be offered for selection include: New Patient Letter or NPL, New Patient Evaluation or NPE, Revisit, etc.

One advantageous functionality is the insertion of objects into reports. In this case, the database may store a disk address (directory tree and file name) where a table, graphic, picture file or other medical imaging file of object is stored, and the object is embedded into the report. Certain specialty practices routinely use medical images and it is advantageous to support including images in reports. Some examples are plastic surgery, dermatology, gastroenterology and pathology. In addition to enhancing the usefulness of the report as a means for inter physician and patient communication, images such as documented photographic evidence are useful to stake and support medical insurance company pre-certifications. Photographic and similar evidence is useful to track recovery progress or decline, to justify and support medical insurance company continued post operative care, and for various other purposes.

Certain providers of medical imaging systems support the handling of images and similar object files. Canfield Mirror, for example, a leader in medical imaging systems, supports imaging to be incorporated in Microsoft documents, presentations and spreadsheets. These files can be stored on the local system hard drive and addressed by drive and directory tree or can be stored on a remote system drive and addressed by http addressing protocols over the web or another network. Preferably, several image insertion choices can be selected, such as inserting one or more images into the body of a printed or rendered medical document, as a thumbnail or as a full resolution image, or as an enclosure with a mailing or an attachment to an email, or by providing a URL or other address or preferably a clickable link whereby the recipient can view an image from a system on which it was stored.

There is a need for streamlining and speeding up the process of recording and disseminating information in healthcare technology solutions. One aspect of the present system is that information categories and aspects are segmented by general and specific topics, and only abnormal findings generally result in a dictation or other free form entry of text. It is not necessary to closely scrutinize portions of the report for transcription errors. Unlike with conventional transcription, the editor/reviewer of the transcription is not required to review and edit a report from top to bottom.

It is possible to replay audio passages when dictating, often over-recording a passage to correct it. Sometimes when rewinding, it is difficult to return to the beginning of a sentence or paragraph, and the dictating person spends time listening to the dictation in order to arrive at the spot where a desired correction is to begin. Although in connection with dictation that is converted and stored in text data format, one can review the converted text during dictation, or restart audio playback at a required position in the recording as delineated by the beginning of a sentence, paragraph, or document. However in that case, the user is bound to find and return to those beginning points. According to the present arrangement wherein the dictation is limited to abnormal categories and the report is segmented into element by element categories and attributes, the current segment can be reviewed and processed as a discrete unit.

In a preferred arrangement, the speech-to-text transcription process can be arranged to automatically transcribe from digitally recorded audio segments any number of documents. The described limitation to dictation of abnormal findings only speeds the transcription process because a given transcription segment might be short enough to transcribe in as little as 10 or 15 seconds. This speed enables a user to produce finished documents at a rate of 240 per hour.

FIGS. 13-16 illustrate some exemplary interface screens and also a finished report document. After synchronization from the practitioner's interface mobile device, remaining needed details can be imported, e.g., from the patient information database or a remote source. These details such as DOB, referring physician, etc., can be reviewed by appropriate selections, e.g., under ‘ready to transcribe’ selected encounter, with a selection made to review background information in the code and/or the SQL database. After the transcription process, the selection box for the patient details/DOB/referring physician and other such details can be moved over under the ‘Not Read’ tab.

The ‘Not Read’ tab is a multi function screen selection from which the user can view/edit the transcribed audio dictation content for use in the final document; review the dictation audio and perform error corrections as needed and save them to the document file; and view a temporary on the fly’ Microsoft Word document. The transcribed ‘findings only’ text is retrieved from the SQL database together with the pre-stored descriptions normal/nominal categories. The transcribed and pre-stored portions auto populate a word document template together with the containing patient/referring physician demographics and pre selected salutation/closing.

Another selectable function is to link or insert objects such as images to appear with the medical document. Sources can be a vendor imaging software system such as the Canfield Mirror medical imaging software, or a standard spreadsheet or presentation format such as Microsoft PowerPoint, or a stored file in jpg, gif, pdf, tif or other format can be copied from or addressed on a local or networked mass storage device (e.g., hard drive). The created/assembled medical document is then rendered in its final state and upon user selection can be approved and finally distributed.

Assembling and rendering a report can include the following steps, which can be selected by default or by keystroke or point and click selection by the operator:
Launching a word processor application such as Microsoft Word;
Choosing a document template is to be utilized for this specific document (e.g., determined at the outset of patient encounter by input on the mobile interface device);
Obtaining transcribed ‘findings only’ text from the SQL database or another location where stored;
Pulling patient/referring physician demographic/date/data from the SQL database or similar storage.
Automatically interleaving or concatenating fields and segments of report including:
   a). Patient demographic
   b). Referring physician demographic
   c). Date
   d). Fax cover sheet when applicable
   e). ‘Findings only’ physician narrative transcription content
   f). Pre prepared template content/legalese
   g). Closing, and
   h). Digitized physician signature

The document is closed in the word processor, which moves on to the next patient document in the queue and the entire process repeats until all documents in the list have been approved/created. There is no practical limit to the number of documents that can be processed and prepared for final approval in this limitless process. As the documents are approved (and printed or transmitted), the patient details move in the interface screen from the ‘Not Read” tab to the Approve’ tab.

Preferably, the entire batch of finished documents are approved in one step. Batch approval reduces that time and attention that would be devoted to printing and attending to the documents immediately after completions. In a batch approval process, an unlimited number of finished reports are finished and printed, faxed, emailed or otherwise dispersed in one step.

The disclosed examples are ‘limitless’ with respect to the length of a dictated narration, which is specific to the category or aspect being discussed but can be any length, and the unlimited number of reports or other documents that can be processed as one unit in certain batch processing steps. These two aspects are advantageous for reasons of convenience and the efficient use of time.

In addition to convenience and efficiency, quality control is an important benefit. Where institutional compliance is mandatory or where a practitioner will benefit from running through a checklist or menu with attention to each of the inquiries that should be addressed according to best practices, the system and also the documentation that is generated provide a safety/archival copy showing that attention was paid to each of the necessary criteria.

The foregoing description details a number of embodiments as examples of the disclosed subject matter, but should not be regarded as exhaustive. The subject invention is not limited to the embodiments and alternatives mentioned as examples. Reference should be made to the appended claims rather than the foregoing discussion of examples, in order to assess the scope of the invention in which exclusive rights are claimed.

What is claimed is:

1. A data processing system for use in assembling reports of procedures, comprising:
at least one data terminal for operation by a practitioner, the data terminal including a facility by which the practitioner inputs selections responsive to prompting and a facility for the operator to input at least one narrative, the selections and the narrative relating to a subject and relating to a process involving the subject;
at least one processor coupled in communication with the data terminal and with a memory including programming and at least one information database, wherein the database contains records relating to at least one of the subject and the process, wherein the processor is programmed to associate the input selections with information from the records; and,
a report generator operable to produce a report containing at least part of the narrative and variably containing portions of the information from the records based upon the input selections.

2. The data processing system for use in assembling reports of procedures according to claim 1, wherein the procedures are one of test and examination procedures on a subject and the system comprises:
a subject encounter and data collection module, a transcription and assembly module and a review and editing module;
wherein the subject encounter module is operable under control of the programming and the practitioner to collect and accumulate said selections and at least one narrative, for successive subjects brought to the attention of the practitioner;
wherein the transcription and assembly module is operable under control of the programming to select from the memory text segments associated with the selections and to concatenate the text segments with the narrative to generate said report for each of the subjects, whereupon the report is stored; and,
wherein the review and editing module is operable in a batch mode to present the reports for said subjects for review and editing.

3. The data processing system for use in assembling reports of procedures according to claim 1, wherein the practitioner is associated with a physician and the subject is one of a succession of patients attended by the physician; wherein the process proceeds according to a predetermined model and comprises at least one of examination of the patient, diagnosis of a condition, and treatment that is determined in part by information communicated from the database to the data terminal for prompting the physician according to points presented on a display of the data terminal.

4. The data processing system for use in assembling reports of procedures according to claim 3, wherein the points presented on the display include at least one option to select an aspect of the patient as nominal and to be reported, at least one option to select an aspect of the patient as nominal and not to be reported, and at least one option to select an aspect of the patient to be addressed by comments in the narrative.

5. A computerized method for composing reports of procedures involving subjects, comprising:
providing at least one data terminal for operation by an operator, the data terminal being controlled by programming for prompting the operator to choose among input selections, and additionally accepting from the operator at least one narrative responsive to said prompting, wherein the input selections and the narrative relate to at least one of a subject and a process involving the subject;
communicating choices made by the operator responsive to the prompting, and also communicating the narrative communication, to a programmed processor coupled to a database;
selecting via the programmed processor a plurality of text segments for a report wherein the text segments selected by the processor are associated with said choices made by the operator and wherein at least one of the text segments is derived from the narrative;
composing a report by concatenating the text segments.

6. The computerized method for composing reports according to claim 5, wherein the operator is an attending physician and the subjects are patients who consult with physician, wherein a consultation with each of the patients is related to a medical objective for a respective said patient, and wherein the input selections offered for prompting are categories include a checklist of topics associated with the objective.

7. The computerized method for composing reports according to claim 6, wherein the categories include one of questioning and examining to determine an attribute of the patient, an assessment of an anatomical feature, and an assessment of a medical condition.

8. The computerized method for composing reports according to claim 7, wherein the data terminal is configured to accept for at least certain prompts alternative responses associated with a nominal reply and a noteworthy reply, wherein the nominal reply indicates one of a normal condition and a condition that is commonly encountered, wherein the data terminal is further configured to accept an input for selecting whether or not at least one said nominal reply shall be reported or not reported, wherein the data terminal is further configured to accept and to associate a freeform narrative comment with at least one said noteworthy reply.

9. The computerized method for composing reports according to claim 8, further comprising accepting the freeform narrative comment via the terminal as an audio signal, digitizing the audio signal, and converting the digitized audio signal to one of the text segments in the report.

10. A computerized system for producing reports of medical procedures involving patients' visits to attending physicians, comprising:
at least one data input terminal provided for operation by an attending physician, the data terminal being controlled by programming to prompt the attending physician to choose among input selections applicable to a patient visit for medical services and to input at least one of a choice and a data value for the input selections;
wherein the input selections include selections for categories of information to be reported about one of the patient and the visit, wherein the selections for at least some said categories include mutually exclusive selections of a normal condition for a respective selection and a noteworthy condition for said respective selection;
wherein the data terminal is operable to accept from the attending physician at least one free form narrative respecting at least one said noteworthy condition;
a network coupling the data terminal for communicating choices made by the operator responsive to the prompting, and also communicating the narrative communication, to a programmed processor coupled to a database;
wherein at least one said programmed processor selects from a data memory at least one predetermined text segment representing at least one of said data value and an explanation of said normal condition for inclusion in a report; and
wherein at least one said programmed processor combines with the predetermined text segment a free form text segment including the free form narrative respecting the noteworthy condition and generates a report from such combination.

11. The computerized system for producing reports according to claim 10, wherein the at least one data terminal includes an audio input; wherein at least one of said data terminal and said at least one programmed processor comprises a speech recognition processor by which the narrative communication is converted from audio to text data; and further comprising a review and revision process wherein the report is presented in a word processor form for review and revision.

12. The computerized system for producing reports according to dam 11, wherein at least one said programmed processor maintains a time stamp correlating the text data to audio, and wherein the review and revision process includes a function to replay portions of the audio correlated to selected parts of the text data during said review and revision.

13. The computerized system for producing reports according to claim 10, wherein the data input terminal is coupled in communication with a patient identification and appointment scheduling workflow system operable to queue a report process commencing with prompting the attending physician, in correspondence with a patient visit, and wherein at least some data is shared by said computerized system for producing reports with at least one of said patient identification and appointment scheduling workflow system and a patient medical information database.

14. The computerized system for producing reports according to claim 10, wherein the data input terminal comprises a wireless terminal and the programming to prompt the attending physician to choose among input selections at least in part comprises an application running on the wireless terminal.

15. The computerized system for producing reports according to claim 14, wherein the data input terminal comprises one of a smart phone, a cellular phone and a portable terminal coupled to the network by at least one of a cellular, Wi-Fi, LAN and WAN data connection.

16. The computerized system for producing reports according to claim 10, wherein the input selections and categories relate to conditions associated with particular medical specialty practices, and wherein the report comprises at least one of a memo to file, a report to a referring physician and a report to an institution.
